(19) United States
(12) Patent Application Publication
(10) Pub. No.: US 2010/0009165 A1
(43) Pub. Date: Jan. 14, 2010

(54) Multifunctional Nanomaterial-Containing Composites and Methods for the Production Thereof

(75) Inventors: Pritesh PATEL, Dublin, OH (US); Gobinath BALASUBRAMANIYAM, Tamilnadu (IN); Jian CHEN, Milwaukee, WI (US)

Correspondence Address: HAYNES AND BOONE, LLP;IP Section, 2323 Victory Avenue, Suite 700, Dallas, TX, 75219, US

(73) Assignee: ZYVEX PERFORMANCE MATERIALS, LLC, Columbus, OH (US)

(21) Appl. No.: 12/170,743

(22) Filed: Jul. 10, 2008

(51) Int. Cl. B32B 5/16; B05D 3/10

(52) U.S. Cl. 428/323; 427/333; 428/339

(57) ABSTRACT

Methods for making multifunctional nanomaterial-containing composites that include the incorporation of nanomaterials into such composites in at least one of two manners: 1) in a solution of dispersed nanomaterials for coating onto a substrate; and 2) by dispersing nanomaterials in a matrix material, such as epoxy, applied to a single substrate layer or sandwiched between adjacent layers in a multiple layer composite. According to such methods, a high loading of nanomaterials may be incorporated into the composites without any deterioration in processing or handling properties.

### TECHNICAL FIELD

The present embodiments relate generally to processes for preparing multifunctional nanomaterial-containing composites and their applications. More particularly, the processes include coating a substrate with a solution of dispersed nanomaterials and a reactive polymer and applying a layer of polymeric material to the coated substrate. In certain embodiments, the polymeric material may also include nanomaterials. In certain other embodiments, multiple layers of the coated substrate are bonded together with the polymeric material with or without nanomaterials. In all cases, the resulting composite materials have high strength, high electrical conductivity, high thermal conductivity, improved thermal stability and in some cases improved radiation shielding effectiveness.

### BACKGROUND

Polymer composites offer several advantages compared to metals and ceramics in that polymer composites are lightweight, have high specific stiffness and strength, are easy to manufacture, have tailorable properties for different applications and have a low coefficient of thermal expansion.

Such polymer composites, however, have disadvantages compared to metals and ceramics. For instance, while polymer composites can be used as structural materials to absorb loads and stresses they do not possess any additional functionality such as electrical or thermal conductivity.

Conventional fillers for polymer composites include carbon fiber, fiber glass, ultra high molecular weight polyethylene (“UHMWPE”) such as is commercially available under the trade name SPECTRA®, poly(ρ-phenylene benzobisoxazole) such as is commercially available under the trade name ZYLON® and certain polyaramid fibers that are commercially available under the trade name KEVLAR®. Such conventional fillers have been used at a rate of approximately 20% to 70% by weight of the polymer matrix in an attempt to achieve high mechanical properties or electrical conductivity, electrostatic discharge (“ESD”), electromagnetic interference (“EMI”), thermal conductivity and radiation properties. However, the loading of such high amounts of conventional fillers in the polymer matrix results in dense composites which sometimes are difficult to process and do not permit a great degree of design freedom.

The use of fabric in the preparation of polymeric composites has also been tried with limited success. For example, fabrics made from conducting fiber, such as carbon fiber produced from a polyacrylonitrile (PAN) or a pitch precursor tend to have poor impact resistance. In addition, such composites require a high percentage of carbon fiber (>60%) to attain the level of conductivity required for certain high end applications, such as defense and aerospace applications, with the results that the composites are quite brittle. Also, anti-ballistic fabrics, such as those which are commercially available under the trade names KEVLAR® and SPECTRA®, are heat-sensitive, which limits their use in environments that require a high continuous service temperature. In addition, the heat sensitivity of such anti-ballistic fabrics cannot be remedied by the addition of a flame retardant. The use of fiberglass has also been attempted but its usefulness for high end applications is very limited because fiberglass does not provide the electrical or thermal properties required for such high end applications.

Further efforts towards making multifunctional polymer composites have included loading carbon fiber and carbon black at a rate of 20-80% by weight into a polymer composite mixture. Polymer composites resulting from such a mixture have electrical conductivity and have achieved 1.9×10⁴ Ω-cm in volume resistivity, but such levels are not high enough to meet the needs of high end defense and aerospace applications. In addition, composites with such a high percentage of carbon black are very difficult to process and sacrifice other mechanical performance.

Carbon nanotubes (sometimes referred to herein as “CNTs”) including single-wall carbon nanotubes (“SWNTs”) and multi-wall carbon nanotubes (“MWNTs”) possess a very desirable and unique combination of physical properties. Specifically, carbon nanotubes due to their high aspect ratio have high mechanical properties, such as tensile strength and tensile modulus, as well as high electrical conductivity, high thermal conductivity, and high thermal stability. In addition to these attributes, carbon nanotubes have the potential for improving the properties of polymer matrices in composites in terms of solvent resistance, stiffness, an increased glass transition temperature (T_{g}) and reduced thermal shrinkage. Moreover, carbon nanotubes are 10⁵ times more resistant to electron radiation than polyethylene and about 10³ times more resistant to electron radiation than highly radiation resistant rigid-rod polymers such as poly(ρ-phenylene benzobisoxazole) which is commercially available under the trade name ZYLON®. Because of their nano-scale diameter and their unique combination of physical properties, carbon nanotubes are thought to be the ultimate carbon fibers for incorporation in high performance, multifunctional polymer composites.

However, previous attempts to make multifunctional polymer composites that include carbon nanotubes, have required a high loading, such as from 10 to 25% by weight and a high dispersion in the host polymer matrix. The loading of such a high level of carbon nanotubes in prior polymer composites significantly increased the melt or solution viscosity of the composite which led to processing problems such as when attempting to spin a conducting fiber. The composites produced according to such parameters were quite brittle. Finally, very expensive spinning apparatus or extruder dies were required to make conducting fiber or yarn from such materials.

The previous attempts to make multifunctional polymer composites that include carbon nanotubes did not fully realize the remarkable mechanical, electrical, and thermal properties of single-wall or multi-wall carbon nanotubes. This is believed to be largely due to the smooth sidewall surfaces of carbon nanotubes that are incompatible with most solvents and polymers, which results in poor dispersion of carbon nanotubes in polymer matrices. In addition, the sidewalls of carbon nanotubes are difficult to functionalize without altering their desirable intrinsic properties. Carbon nanotubes with unfunctionalized sidewalls have poor adhesion with polymer matrices and, for example, typical unfunctionalized single-wall and multi-wall carbon nanotube/epoxy composites, are either mechanically weaker or barely stronger than pristine epoxy.

Currently, protection against the deleterious health effects of radiation is mainly achieved by limiting access to high radiation environments, controlling the duration of radiation exposure, and by using materials to absorb radiation or degrade its energy. Spacecraft inhabited by humans have primarily been constructed of aluminum; however, measurements made in spacecraft and at accelerators have shown that aluminum is not a very effective shielding material with respect to highly charged energetic heavy ions (such as iron ions) known as HZE particles.

Polyethylene has a high hydrogen content of about 14% by weight and has been identified as a promising shielding material against galactic cosmic rays (GCRs) and solar particle events (SPEs), which are the two primary types of space radiation beyond Earth's magnetic field. The preferred configuration of polyethylene for space radiation shielding effectiveness is pure polyethylene blocks. However, pure polyethylene blocks have poor mechanical strength and poor electrical conductivity, which limit the potential for using blocks of pure polyethylene for multifunctional purposes. In an attempt to overcome this problem, high strength polyethylene fibers have been used to reinforce a polymer matrix such as epoxy. The resulting composite material is lighter and several times stronger than aluminum; however, the resulting composite material lacks the electrical and thermal conductivity provided by aluminum.

Accordingly, a need exists for a multifunctional composite material that has high mechanical strength, high electrical conductivity, high thermal conductivity, improved thermal stability and in some cases improved radiation shielding effectiveness.

### BRIEF DESCRIPTION OF THE DRAWINGS

Aspects of the present disclosure are best understood from the following detailed description when read with the accompanying figures. It is emphasized that various features are not drawn to scale. In fact, the dimensions of the various features may be arbitrarily increased or reduced for clarity of discussion.

FIG. 1 is a schematic view of a multifunctional composite that includes two modes of incorporation of nanomaterials;

FIG. 2 is a schematic view of a three roll mill apparatus for improving the dispersion of carbon nanotubes in resin;

FIG. 3 is a scanning electron microscopy image of carbon nanotubes coated onto polyethylene fabric;

FIG. 4 is a schematic view of apparatus for performing radiation shielding tests;

FIG. 5 is a schematic view of apparatus for performing radiation shielding tests;

FIG. 6 is a graph of the absorbed dose data taken with a 1000 MeV/n iron ion beam;

FIG. 7 is a scanning electron microscopy image of raw nanotubes;

FIG. 8 is a scanning electron microscopy image of polyphenyleneethynylene (“PPE”) dispersed nanotubes;

FIG. 9 shows scanning electron microscopy images showing nanotubes bridging a crack under stress;

FIG. 10 is schematic view of apparatus for performing shielding effectiveness tests;

FIG. 11 is a graph of the reflected portion of the shielding effectiveness; and

FIG. 12 is a graph of the absorbed portion of the shielding effectiveness.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity, and does not in itself dictate a relationship between the various embodiments and/or configurations discussed.

Embodiments of the present invention include multifunctional nanomaterial-containing composites and processes for the production thereof. As used herein, the term “multifunctional” shall mean and refer to materials that have additional and/or enhanced physical properties that such materials would not have without the incorporation of nanomaterials. The additional and/or enhanced physical properties include one or more of tensile strength, tensile modulus, impact resistance, compression strength, high electrical conductivity, and high thermal conductivity. According to such embodiments of the present invention, the multifunctional nanomaterial-containing composites are prepared by:

(a) preparing a solution of dispersed nanomaterials comprising nanomaterials, a reactive polymeric dispersing agent for non-wrapping non-covalent functionalization of the nanomaterials and a solvent;

(b) coating a substrate with the solution of dispersed nanomaterials to form a substrate layer, wherein the surface of the substrate is functionalized so as to covalently bond with the reactive polymeric dispersing agent; and

(c) applying a layer of matrix material to the substrate layer, wherein the matrix material comprises a polymeric material,

wherein the polymeric material covalently bonds with the reactive polymeric dispersing agent and the functionalized surface of the substrate.

According to another embodiment of the present invention, the matrix material comprises a polymeric material, nanomaterials, and a reactive polymeric dispersing agent for non-wrapping non-covalent functionalization of the nanomaterials.

According to certain embodiments of the present invention, the processes for making the multifunctional nanomaterial-containing composites include preparing a composite of two or more substrate layers. According to such embodiments, a layer of matrix material is sandwiched between each adjacent substrate layer.

The term “nanomaterial,” as used herein, includes, but is not limited to, functionalized and solubilized multi-wall carbon or boron nitride nanotubes, single-wall carbon or boron nitride nanotubes, carbon or boron nitride nanoparticles, carbon or boron nitride nanofibers, carbon or boron nitride nanoropes, carbon or boron nitride nanoribbons, carbon or boron nitride nanofibrils, carbon or boron nitride nanoneedles, carbon or boron nitride nanosheets, carbon or boron nitride nanorods, carbon or boron nitride nanohoms, carbon or boron nitride nanocones, carbon or boron nitride nanoscrolls, graphite nanoplatelets, nanodots, other fullerene materials, or a combination thereof. The term “nanotubes” is used broadly herein and, unless otherwise qualified, is intended to encompass any type of nanomaterial. Generally, a “nanotube” is a tubular, strand-like structure that has a circumference on the atomic scale. For example, the diameter of single-wall nanotubes typically ranges from approximately 0.4 nanometers (nm) to approximately 100 nm, and most typically ranges from approximately 0.7 nm to approximately 5 nm.

According to certain embodiments of the present invention, the functionalization of the substrate surface which enables the reactive polymeric dispersing agent to covalently bond with the substrate and with the polymeric material as well as the selection of side groups on the reactive polymeric dispersing agent that enable the reactive polymeric dispersing agent to covalently bond with the functionalized substrate surface and the polymeric material enables significantly enhanced adhesion between the nanomaterials and the substrate and the polymeric material without compromising the intrinsic properties of the nanomaterials.

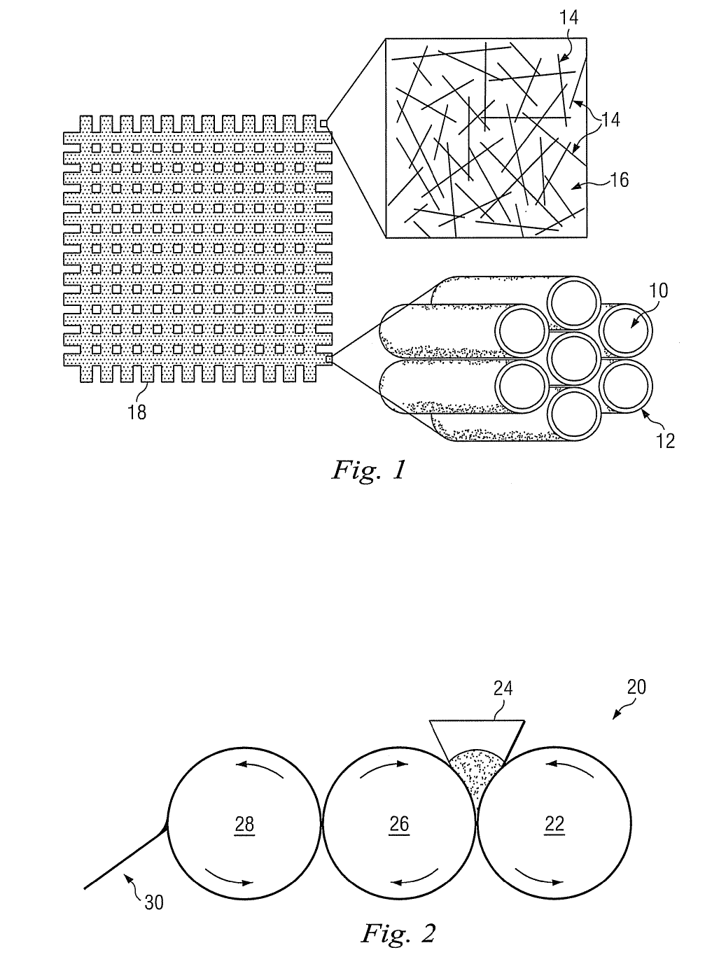

According to certain embodiments of the present invention and as shown schematically in FIG. 1, the substrate 10 is coated with a solution of dispersed nanomaterials 12 and nanomaterials 14 are dispersed in the polymeric material 16. According to such embodiments, nanomaterials are incorporated into the composite 18 in two ways, namely in the coating on the substrate 10 and in the polymeric material 16 applied to the coated substrate 12.

According to certain embodiments of the present invention, two or more layers of the coated substrate are bonded together. According to such embodiments, the substrate comprises approximately 50% by weight of the final composite.

According to certain embodiments of the present invention, the substrate may be a polymeric material in a woven, non-woven or film form. According to other embodiments of the present invention, the substrate may be formed from cotton, fiberglass, ceramic or metallic material.

According to still other embodiments, the multifunctional nanomaterial-containing composites, may include additives such as a plasticizer, a softening agent, a filler, a reinforcing agent, a processing aid, a stabilizer, a viscosity modifier, an antioxidant, a binder, a cross-linking agent, a UV absorbent agent, a flame retardant, an impact modifier, a lubricant or a charge adjusting agent.

According to certain embodiments of the present invention, the multifunctional nanomaterial-containing composites demonstrate electrical conductivity with a very low percolation threshold at a loading of about 0.5-6.0 weight percent of nanomaterials. A percolation network is necessary for a material to be conductive. The percolation threshold of nonconductive materials can be overcome by applying a layer of a conductive material to the nonconductive material. According to certain embodiments of the present invention, the nanomaterials provide a percolation network and can overcome the percolation threshold of a nonconductive material at a lower concentration when the nanomaterials are dispersed by a reactive polymeric dispersing agent in comparison to nanomaterials that are not so dispersed. The low loading of nanomaterials in the composites prepared according to the present embodiments enables conductivity levels required for various electrical applications to be achieved without compromising the other preferred physical properties and processability of the composites.

In general, the required electrical resistivity p or inverse conductivity is based on the application; e.g. antistatic material (ρ˜10⁸-10¹² Ω-cm), static dissipative material (ρ˜10²-10⁸ Ω-cm), electrical conductivity (ρ<10² Ω-cm) and highly conducting material (ρ˜10⁻⁸-10⁻¹² Ω-cm). The in-plane electrical resistivity, which is the inverse of conductivity, of the multifunctional nanomaterial-containing composites of the present invention is about 30-60 Ω-cm while the in-plane electrical resistivity of similar composites without nanomaterials is about 10¹⁴ Ω-cm. Thus, the incorporation of nanomaterials into the composites prepared according to the methods of the present invention reduces the resistivity of the composites by approximately 14 orders of magnitude. In comparison, similar composites prepared using carbon black rather than nanomaterials have low conductivity with an electrical resistivity of about 10⁴ Ω-cm. In addition, the carbon black composites required a very high loading of carbon black of about 30% to achieve this electrical resistivity and the resin from which such composites were made was a highly viscous material that was very difficult to process.

Also, by incorporating nanomaterials into the composites by coating them on the substrate and by incorporating them into the polymeric material that is applied to the coated substrate enables a high loading of nanomaterials into the composites, resulting in increased electrical and thermal conductivity without compromising the properties of the composites. For instance, a composite could be made having a 10% loading by weight of nanomaterials. If the composite was made by incorporating the nanomaterials solely into the polymeric material, the polymeric material would be extremely difficult to process and the resulting composite would be quite brittle. According to embodiments of the present invention, however, in which nanomaterials are incorporated into a coating on a substrate and into the polymeric material, the processability of such composites is not compromised.

The multifunctional nanomaterial-containing composites prepared according to the embodiments of the present invention have properties that make them particularly useful in applications requiring properties such as electrostatic discharge, electromagnetic interference, high electrical conductivity, thermal conductivity and improved mechanical properties. For instance, the multifunctional nanocomposite containing composites are useful for: lightweight, multifunctional structural components for aerospace transportation vehicles that will enable increased radiation shielding, increased strength and longevity, improved energy efficiency, and improved vehicle payload mass to liftoff mass ratios; structural components for space structures (such as space stations, orbiters, landers, rovers, habitats, crew exploratory vehicles, etc.) that combine strength and radiation shielding; components for liquid hydrogen tanks; components and coatings for deep space power systems, and in-space manufacturing and repairing; advanced materials for fabrics and coatings used in space suits, particularly as a thermally conductive material for the inner layer of a space suit to conserve body heat, and other space applications; coatings and bonding agents for high-value components and equipment (examples include EMI shielding materials, ESD protection, ultra-strong adhesives, and conductive coatings for aerospace systems and components); composites for satellite armor; intelligent or smart composites—composites with health monitoring capabilities; space and aerospace crafts and habitats for commercial space travel; components for particle accelerators and nuclear reactors; radioactive chemical, biological and nuclear waste containment vessels; advanced materials for medical applications such as fabrication of prostheses and splints; structural components for high-value civilian transportation applications (for example, more extensive use of composites for airframes, helicopter rotors, and skins); lightweight, multifunctional materials for ballistics protection, soldier uniforms, armor, and helmets; professional sports and leisure equipment such as golf clubs, fishing rods, and tennis equipment; advanced flywheels capable of significantly higher rotational speeds; and materials for competitive yachting and car racing.

According to certain embodiments of the present invention, the multifunctional nanomaterial composites include a high loading of from 0.1% to 20% by weight of nanomaterials without any dispersing problems.

According to certain embodiments of the present invention, multifunctional composites of multi-walled carbon nanotubes, with a polyethylene fabric substrate as a reinforcement and epoxy as a polymeric material were prepared. Such composites had an electrical resistivity of about 52-57 Ω-cm, an improved tensile modulus compared to pure polyethylene and similar composites without nanomaterials and no degradation in radiation shielding performance compared to pure polyethylene.

According to such embodiments, a composite comprising carbon nanotubes and polyethylene was prepared. The shielding effectiveness of the composite was studied by exposing it to simulated space radiation using particle accelerator facilities. Physical properties of the composite (visual analysis using SEM, electrical conductivity, EMI shielding effectiveness, mechanical properties and thermal properties) were evaluated before and after radiation of the composite.

The composites had a loading of about 8.0% by weight of carbon nanotubes and had a very low electrical resistivity of 52-57 Ω-cm which was 14 orders of magnitude less than a similarly constructed sample that did not include carbon nanotubes. The composites also compared quite favorably to composites made with conventional fillers like carbon black which do not achieve the same conductivity even at higher loading of 20-30% with a consequent increase in processing difficulties. The composites also exhibited good EMI shielding capabilities of >40 dB. The performance of the carbon nanotube/polyethylene composites with respect to radiation shielding was equal to pure polyethylene blocks and demonstrated that such carbon nanotube/polyethylene composites can act as an efficient space radiation shield and provide protection against high energy protons during solar particle events. The processes of the present embodiments enabled the highly desirable thermal properties of the carbon nanotubes to be transferred to the composites as substantiated by the thermal stability of the composite which was suitable for most applications as it did not degrade at temperatures up to 300° C. The composites were also lightweight and low in density. In particular, according to certain embodiments, the composite had a density of 1.1 gm/cm³.

### Preparation of Solution of Dispersed Nanomaterials:

According to certain embodiments of the present invention, the process includes dispersing nanomaterials in reactive polymeric dispersing agents in a solvent to form a solution of dispersed nanomaterials. The reactive polymeric dispersing agents, include polymers that are based on the following poly(phenyleneethynylene)(“PPE”) structure:

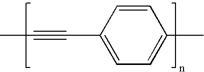

The basic PPE structure shown above is known to those of ordinary skill in the art. See Bunz, U. H. F. Chem. Rev. 2000, 100, 1605-1644 and McQuade, D. T. et al., J. Am. Chem. Soc. 2000, 122, 12389-12390.

The nanomaterials may be dispersed in the reactive polymeric dispersing agent by any means known to those of ordinary skill in the art such as by sonication, high shear mixing, three roll mill calendaring, and high pressure processing through a micron size capillary tube to achieve high shear, and vibration. Carbon nanotubes in their native form tend to bundle together and form agglomerates. Thus, in embodiments of the present invention in which the nanomaterials comprise carbon nanotubes, sonication is useful to aid in the initial exfoliation or debundling of the carbon nanotubes and also tends to evenly distribute the agglomerated carbon nanotubes in the solvent. Apparatus for performing three roll mill calendaring is shown schematically in FIG. 2. As shown in FIG. 2, such apparatus 20 includes a feed roll 22, a supply of a mixture of the nanomaterials, the reactive polymeric dispersing agent and the solvent 24, a center roll 26, an apron roll 28 and an apron take off 30. As shown in FIG. 2, the feed roll 22 is driven in a counterclockwise manner, the center roll 26 is driven in a clockwise manner and the apron roll 28 is driven in a counter-clockwise manner. The mixture of the nanomaterials, the reactive polymeric dispersing agent and the solvent 24 is delivered between the center roll 26 and the feed roll 22, and is driven between the center roll 26 and the apron roll 28 to disperse the nanomaterials in the reactive polymeric dispersing agent. The dispersed materials may then be run through the apparatus 20 multiple times to achieve the desired degree of dispersion. The dispersed materials are then delivered for further processing.

The reactive polymeric dispersing agents non-covalently bond to and functionalize the nanomaterials in a non-wrapping fashion. Such non-wrapping functionalization of the nanomaterials involves the attachment of the reactive polymeric dispersing agents to the surface of the nanomaterials by non-covalent bonding instead of covalent bonding. Consequently, the underlying electronic structure of the nanomaterials and their key attributes are not affected.

As used herein, the term “non-wrapping” means not enveloping the diameter of the nanomaterials with which a reactive polymeric dispersing agent is associated. Thus, associating a reactive polymeric dispersing agent with nanomaterials in a “non-wrapping fashion” encompasses an association of the reactive polymeric dispersing agent with the nanomaterials in which the reactive polymeric dispersing agent does not completely envelop the diameter of the nanomaterials.

The reactive polymeric dispersing agents disclosed herein comprise backbones that provide modular monomer units having at least one electron donating substituent or at least one electron withdrawing substituent, which reactive polymeric dispersing agents enable exfoliation of nanomaterials and dispersion in a solvent. The reactive polymeric dispersing agents may include substituents and/or side chains that affect dispersion behavior, and enhance adhesion in the multifunctional nanomaterial-containing composites of the present invention. The substituents and/or side chains of the reactive polymeric dispersing agents can be added after polymerization of the reactive polymeric dispersing agent and even after mixture of the reactive polymeric dispersing agent with nanomaterials as disclosed in U.S. Patent Publication No. 2006/0054866, the entire disclosure of which is incorporated herein by reference. The selection of side chains on the reactive polymeric dispersing agents enables the reactive polymeric dispersing agents to achieve specific properties, such as solubility in different solvents and adhesion to different materials, thus, for instance allowing for the improvement of the interface between the nanomaterials and the polymeric materials, as well as the interface between the nanomaterials and the substrate.

To exfoliate, disperse/solubilize and functionalize nanomaterials, the reactive polymeric dispersing agents having modular monomer units including at least one electron donating substituent or at least one electron withdrawing substituent as described herein are mixed with the nanomaterials in a solvent. The solvent may be water, chloroform, dichlorobenzene, or any of a number of halogenated and non-halogenated organic solvents as described below. As noted above, the reactive polymeric dispersing agents associate with the nanomaterials in a non-wrapping fashion.

In certain embodiments, the nanomaterials can be dispersed at a loading of from about 0.25% to about 10% by weight, in a reactive polymeric dispersing agent that has the capability of dispersing the nanomaterials as well as cross linking with functional groups on the surface of a substrate.

According to certain embodiments of the present invention, the solution of dispersed nanomaterials may additionally include a low molecular weight polymer. Such low molecular weight polymers can be selected specifically to covalently bond with the reactive polymeric dispersing agent and the functionalized surface of the substrate as discussed below. The low molecular weight polymers can be any of the thermoset or thermoplastic polymers discussed below.

### Coating of a Substrate:

A substrate is coated with the solution of dispersed nanomaterials. The substrate can be formed from polymeric material, cotton, fiberglass, metal, or ceramic material. In certain embodiments, the substrate comprises a polymeric material in the form of a woven or non-woven fabric or film. The polymeric material can be a thermoset polymer, a thermoplastic polymer, a conducting thermoplastic polymer, an elastomer or an inorganic polymer. According to certain embodiments of the present invention, the substrate is a fabric material formed of continuous or discontinuous fibers such as carbon fibers, carbon nanotube fibers, carbon nanotube nanocomposite fibers, polyaramid fibers such as those sold under the trade name KEVLAR®, poly(ρ-phenylene benzobisoxazole) fibers such as those sold under the trade name ZYLON®, ultrahigh molecular weight polyethylene fibers such as those sold under the trademark SPECTRA®, high density polyethylene fibers, low density polyethylene fibers, linear low density polyethylene fibers, polypropylene fibers, nylon fibers, cellulose fibers, natural fibers, biodegradable fibers and combinations thereof.

The solution of dispersed nanomaterials can be applied so as to coat one or both sides of the substrate. The coating of the substrate with the solution of dispersed nanomaterials may be accomplished by any coating technique well known to those of ordinary skill in the art such as spraying, vacuum deposition, dip coating, extrusion, calendaring, powder coating, transfer coating, air knife coating, roller coating and brush coating. The substrate may be coated with one or more layers of the solution of dispersed nanomaterials and the integrity of the coating is inspected by visual examination. While the composition that includes the dispersed nanomaterials and the reactive polymeric dispersing agent has been described as being in the form of a solution, those of ordinary skill in the art will recognize that the composition can be in any suitable form such as a slurry, emulsion, suspension, gel and combinations thereof.

According to certain embodiments of the present invention, the surface of the substrate is functionalized with chemical groups designed to aid in forming covalent bonds with the reactive polymeric dispersing agents that are coated onto the substrate and with the polymeric material that is applied to the coated substrate. The functionalization of the substrate changes the atomic structure of the surface of the substrate so as to enhance its reactivity. Functionalization beyond the surface of the substrate is minimized since “deep” functionalization tends to significantly reduce the otherwise desirable properties of composites that include the functionalized substrate such as its radiation shielding properties.

According to certain embodiments of the present invention, in which the substrate comprises a polyethylene fabric substrate, such polyethylene fabric substrates were functionalized by a fluoro-oxidation treatment which uses fluorine and oxygen to oxidize the hydrogen groups in polyethylene to polar functional groups such as epoxide, carboxylate and hydroxyl groups. Such fluoro-oxidation treatment processes are well known in the art such as the processes disclosed in U.S. Pat. No. 4,020,223 the entire disclosure of which is hereby incorporated herein by reference. The fluoro-oxidation treatment was carried out in very mild conditions to prevent damage to the polymer backbone. The skin depth to which the treatment was carried was approximately 3 nm. This fluoro-oxidation functionalization method left the bulk of the polyethylene in the substrate unchanged.

According to such embodiments, the polyethylene fabric functionalized by an epoxide, carboxylate or hydroxyl group was cross-linked to the functional groups on the reactive polymeric dispersing agent. According to such embodiments, the weight percent of the reactive polymeric dispersing agent ranged from about 0.1 to about 40% in the overall composites.

According to certain embodiments of the present invention, the coating of the dispersed nanomaterials on the substrate makes a porous network of nanomaterials, such that the polymeric material that is applied to the substrate can either penetrate through the porous nanomaterial network to interact with un-reacted functional groups on the surface of the functionalized substrate or interact with functional groups on the reactive polymeric dispersing agent.

### Application of a Layer of Polymeric Material to the Coated Substrate:

According to embodiments of the present invention, composites are prepared by applying a layer of polymeric material to a coated substrate. According to certain embodiments, nanomaterials are dispersed in the polymeric material, such as epoxy resin, at a loading of from about 0.25% to about 10% by any mechanical mixing or high shear mixing techniques well known to those of ordinary skill in the art, followed by three roll mill processing as shown schematically in FIG. 2 and as described above. According to such embodiments, the polymeric material includes the nanomaterials, a reactive polymeric dispersing agent to disperse the nanomaterials, and optionally a solvent. According to such embodiments, the solvent may advantageously be used to control the viscosity of the polymeric material, the nanomaterials and the reactive polymeric dispersing agent.

As noted above, according to certain embodiments of the present invention, the polymeric material is selected so as to react with and covalently bond to both the functionalized surface of the substrate and the reactive polymeric dispersing agent. The resulting composites have improved interface properties compared to composites that lack the beneficial combination of a polymeric material that reacts with and covalently bonds to both the surface of a substrate and the constituents of a coating on the substrate. Multi-layer composites that do not include this beneficial combination tend to have poor interface properties and are subject to significant delamination of the layers.

### Bonding Together of Multiple Coated Substrate Layers:

The coated substrate layers are bonded together using various well known polymer processing techniques such as compression molding, resin transfer molding, resin infusion, reaction injection molding, pre-preg, thermoforming, hand lay-up, casting or open molding, autoclave molding, filament winding, pultrusion, or a combination thereof. The compression molding of the coated substrate layers can also be performed when the pre-bonded materials are in a dough molding compound, bulk molding compound or sheet molding compound form. As is well known in the art, the hand lay-up process is performed by taking one layer of the coated substrate, applying a polymeric material, as described above, and applying a second layer of the coated substrate to the first layer with the polymeric material sandwiched therebetween. This process is then repeated until a composite with a desired thickness is achieved. According to certain embodiments of the present invention, a composite that includes 15 layers of the coated substrate with polymeric material sandwiched therebetween generated a final product having a thickness of ⅛″ after compression molding.

Prior to bonding together the coated substrate layers, a polymeric material, as described above, with or without nanomaterials dispersed therein, is applied to the coated substrate layers so that the polymeric material is disposed between each layer of the finished composite material.

### Polymers:

Examples of thermoset polymers that may be used according to certain embodiments of the present invention include thermoset resins (such as polyester resin and epoxy resin), polyimides, cyanate esters, bismaleimides, benzoxazines, phthalonitriles, vinylesters, phenolics, poly(ρ-phenylene benzobisoxazole), allyl resin, melamine resin, urea-formaldehyde, melamine formaldehyde, phenol-formaldehyde, polydicyclopentadiene (PDCPD), furfuraldehyde and combinations thereof.

Examples of thermoplastic polymers or prepolymers that may be used according to certain embodiments of the present invention include polyethylene, polyphenylenes such as PARMAX®, poly(phenylene oxide), polyketone, cellulose, polyimide, poly(methyl methacrylate), poly(vinylidene chloride), poly(vinylidene fluoride), polycarbonate, polypropylene, poly(vinyl chloride), poly(ether sulfone), poly(vinyl acetate), polystyrene, polyester, polyvinylpyrrolidone, polycyanoacrylate, polyacrylonitrile, acrylonitrile butadiene styrene, polyamides (such as aramids, nylons and KEVLAR®), poly(aryleneethynylene), poly(phenyleneethynylene), polyester resin (such as polyethylene terephthalate), ethylene vinyl alcohol, fluoropolymers (such as polytetrafluoroethylene, fluoroethylene propylene, perfluoroalkoxyalkane, chlorotrifluoroethylene, ethylene chlorotrifluoroethylene, and ethylene tetrafluoroethylene), polyacrylates, polybutylene, polyethylenechlorinates, polymethylpentene, polyamide-imide, polyaryletherketone, polyetheretherketone, polyetherimide, polyphthalamide, polysulfone and combinations thereof.

Examples of conducting thermoplastic polymers that may be used according to certain embodiments of the present invention include poly(acetylene)s, poly(pyrrole)s, poly(thiophene)s such as poly(3-hexylthiophene), poly(aniline)s, poly(fluorene)s, polynaphthalenes, poly(ρ-phenylene sulfide), poly(ρ-phenylene vinylene)s, ionomers, other conjugated polymers (e.g., conducting polymers) and combinations thereof.

Examples of elastomers that may be used according to certain embodiments of the present invention include polyisoprene, polybutadiene, polyisobutylene, polychloroprene, silicone, polyurethane, styrene butadiene rubber (SBR), hydrogenated nitrile butadiene rubber (HNBR) and combinations thereof.

Examples of inorganic polymers that may be used according to certain embodiments of the present invention include polysiloxane, polysilane, polycarbosilane, polygermane, polystannane, polyphosphazene, and combinations thereof.

### Carbon Nanotubes:

Multi-wall carbon nanotubes for use in the processes of the present invention are commercially available from the Arkema Group, France. Single-wall carbon nanotubes for use in the processes of the present invention may be produced by a high pressure carbon monoxide process (HiPco) and are commercially available from Carbon Nanotechnologies, Inc. (Houston, Tex.). Carbon nanotubes made by arc discharge, laser vaporization, or other methods known to those of ordinary skill in the art may also be used in the processes of the present invention.

### Reactive Polymeric Dispersing Agents:

As noted above, the reactive polymeric dispersing agents that may be used according to certain embodiments of the present invention have a backbone that includes modular monomer units having at least one electron donating substituent and at least one electron withdrawing substituent, which polymers enable exfoliation of carbon nanotubes and dispersion in a solvent. The specific rigidity of various backbones that may be implemented in the reactive polymeric dispersing agents may vary, but such backbones are preferably sufficiently rigid such that they do not wrap (i.e., fully envelop the diameter of) the nanomaterials with which they are associated. Side chains, extensions and functional groups attached to the backbone of such reactive polymeric dispersing agents may extend about all or a portion of the diameter of the nanomaterials, but the backbone of the polymer is sufficiently rigid such that it does not wrap about the diameter of the nanomaterials with which it is associated.

Examples of particular reactive polymeric dispersing agents and methods for the synthesis thereof that may be used according to certain embodiments of the present invention include polymers disclosed in U.S. Patent Publication No. US 2006/0054866, the entire disclosure of which is incorporated herein by reference.

The “arylene” of “poly(aryleneethynylene),” as used herein, means phenyl, diphenyl, naphthyl, anthracenyl, phenanthrenyl, pyridinyl, bis-pyridinyl, phenanthrolyl, pyrimidinyl, bis-pyrimidinyl, pyrazinyl, bis-pyrazinyl, aza-anthracenyl, or isomers thereof, for example.

According to certain embodiments of the present invention, the reactive polymeric dispersing agent is a poly(phenyleneethynylene) that comprises structure Pₐ, P_{b}, or P_{c} as follows:

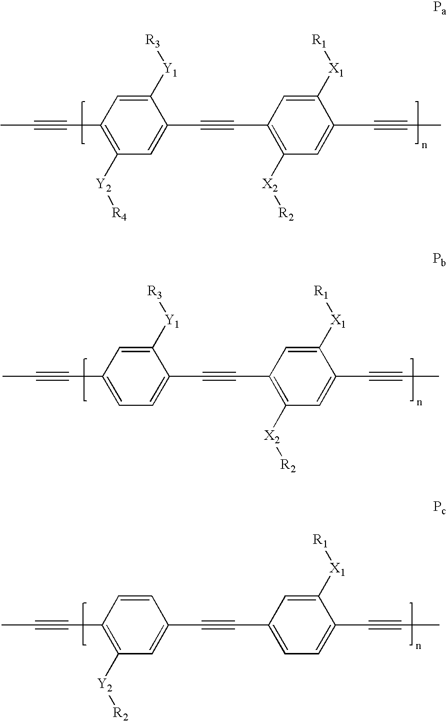

For structures Pₐ, P_{b}, and P_{c}, the designation “X” refers to an X substituent, such as X₁ or X₂; the designation “Y” refers to a Y substituent, such as Y₁ or Y₂; the designation “R” refers to an R group, such as R₁, R₂, R₃, or R₄; and n is from about 20 to about 190.

Structure Pₐ has a first monomer portion that is substituted with Y₁R₃ and Y₂R₄, and a second monomer portion that is substituted with X₁R₁ and X₂R₂. Structure P_{b} has a first monomer portion that is monosubstituted with Y₁R₃ and a second monomer portion that is substituted with X₁R₁ and X₂R₂. Structure P_{c} has a first monomer portion that is monosubstituted with Y₂R₂ and a second monomer portion that is monosubstituted with X₁R₁. X₁R₁, X₂R₂, Y₁R₃, Y₂R₄, and Y₂R₂ are either electron donating or electron withdrawing substituents and, in particular, when the poly(phenyleneethynylene) polymer has the structure Pₐ and when X₁R₁ and X₂R₂ are electron donating, then Y₁R₃ and Y₂R₄ are electron withdrawing; and when X₁R₁ and X₂R₂ are electron withdrawing, then Y₁R₃ and Y₂R₄ are electron donating. Further, when the poly(phenyleneethynylene) polymer has the structure P_{b} and when X₁R₁ and X₂R₂ are electron donating, then Y₁R₃ is electron withdrawing; and when X₁R₁ and X₂R₂ are electron withdrawing, then Y₁R₃ is electron donating. In addition, when the poly(phenyleneethynylene) polymer has the structure P_{c} and when X₁R₁ is electron donating, then Y₂R₂ is electron withdrawing, and when X₁R₁ is electron withdrawing, then Y₂R₂ is electron donating.

The term “monomer portion,” as used herein, means one arylene with bound substituent groups of a modular monomer unit of poly(phenyleneethynylene).

The term “electron withdrawing,” as used herein, means that an atom in a covalent bond has a greater tendency to attract shared electrons from the other atom. The term “electron donating,” as used herein means that an atom in a covalent bond has a greater tendency to “give-up” shared electrons to the other atom. Since each monomer unit of a poly(aryleneethynylene) polymer having one of structures Pₐ, P_{b}, and P_{c} as set forth herein comprises at least two monomer portions, wherein one of the monomer portions has at least one electron donating substituent and the other monomer portion has at least one electron withdrawing substituent, the electronic properties of the poly(aryleneethynylene) polymer are, therefore, fine-tuned.

According to certain embodiments of the present invention, the reactive polymeric dispersing agent is a poly(phenyleneethynylene) that comprises structure P_{d} as follows:

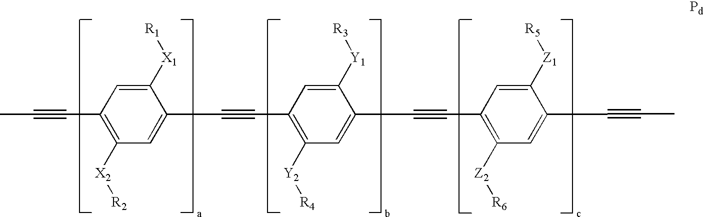

For structure P_{d}, the designation “X” refers to an X substituent, such as X₁ or X₂; the designation “Y” refers to a Y substituent, such as Y₁ or Y₂; the designation “Z” refers to a Z substituent, such as Z₁ or Z₂; the designation “R” refers to an R group, such as R₁, R₂, R₃, R₄, R₅ or R₆; and a+c=b where b is greater than 10 and less than 96.

Structure P_{d} has three monomer units in which the first monomer portion designated as “a” is disubstituted with X₁R₁ and X₂R₂, the second monomer portion designated as “b” is disubstituted with Y₁R₃ and Y₂R₄, and the third monomer portion designated as “c” is disubstituted with Z₁R₅ and Z₂R₆. In structure P_{d}, X₁R₁, X₂R₂, Y₁R₃, Y₂R₄, Z₁R₅ and Z₂R₆ are either electron donating or electron withdrawing substituents and when Y₁R₃ and Y₂R₄ are electron withdrawing, then X₁R₁, X₂R₂, Z₁R₅ and Z₂R₆ are electron donating; and when Y₁R₃ and Y₂R₄ are electron donating, then X₁R₁, X₂R₂, Z₁R₅ and Z₂R₆ are electron withdrawing.

For structures Pₐ, P_{b}, P_{c}, or P_{d}, X₁, X₂, Y₁, Y₂, Z₁ and Z₂ are independently, CO, COO, CONH, CONHCO, COOCO, CONHCNH, CON, COS, CS, CN, CNN, SO, SO₂, NO, PO (all electron-withdrawing substituents); alkyl (methyl, ethyl, propyl, for example, and up to 10, 20, 30, 40 or 50 carbons), aryl, allyl, N, S, O, or P (all electron-donating substituents).

Also, for structures Pₐ, P_{b}, P_{c}, or P_{d}, R₁, R₂, R₃, R₄, R₅ and R₆ are independently, an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, alkyl, allyl, antibiotic, aryl, azide, aziridine, azo compounds, benzyl, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, epoxide, ester, ether, ethylene glycol, fullerene, glyoxal, halide, hydrogen, hydroxy, imide, imine, imidoester, isothiocyanate, isocyanate, isonitrile, ketone, lactone, ligand for metal complexation, ligand for biomolecule complexation, lipid, maleimide, melamine, metallocene, NHS ester, nitrile, nitroalkane, nitro compounds, nucleotide, olefin, oligosaccharide, peptide, phenyl, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, urethane and combinations thereof.

According to such embodiments, the R groups, which may be the same or different, comprise any group, or combination of groups, suitable for further manipulation, that is a “manipulation group.” Groups suitable for use as R groups include any group that has properties that can be modified. The R groups may be selected to provide interaction with the substrate as well as with the polymeric material. The R groups are also useful for enhancing either or both of the dispersion and solubilization of nanomaterials by the reactive polymeric dispersing agent. The presence of the R groups may be measured by IR, proton NMR, or carbon NMR, for example.

According to certain embodiments of the present invention, the reactive polymeric dispersing agent includes PPE modular polymers having the structure P_{d}, where X₁R₁═X₂R₂, Y₁R₃═Y₂R₄, and Z₁R₅=Z₂R₆, where X₁═X₂═COO, Y₁═Y₂═O and Z₁=Z₂=COO, and where R₁═R₂═(CH₂)₈((CH₂)₂O), R₃═R₄═C₁₀H₂₁, and R₅═R₆═(C₂H₄O)₂CH₃.

### Solvents:

According to certain embodiments of the present invention, the solvents in which the nanomaterials and the reactive polymeric dispersing agent are dispersed include organic or aqueous solvents such as, water, acetic acid, acetone, acetonitrile, aniline, benzene, benzonitrile, benzyl alcohol, bromobenzene, bromoform, 1-butanol, 2-butanol, carbon disulfide, carbon tetrachloride, chlorobenzene, chloroform, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, or N-methyl-2-pyrrolidone.

According to other certain embodiments of the present invention, the solvents in which the nanomaterials and the reactive polymeric dispersing agent are dispersed include ionic liquids or supercritical solvents. Examples of suitable ionic liquids include, for example, tetra-n-butylphosphonium bromide, tetra-n-butylammonium bromide, 1-ethyl-3-methyl-imidazolium chloride, 1-butyl-3-methyl-imidazolium chloride, 1-hexyl-3-methyl-imidazolium chloride, 1-methyl-3-octyl-imidazolium chloride, 1-butyl-4-methyl-pyridinium chloride, 1-ethyl-3-methyl-imidazolium tetrafluoroborate, 1-butyl-3-methyl- imidazolium tetrafluoroborate, 1-hexyl-3-methyl-imidazolium tetrafluoroborate, 3- methyl-1-octyl-imidazolium tetrafluoroborate, 1-butyl-4-methyl-pyridinium tetrafluoroborate, 1-ethyl-3-methyl-imidazolium hexafluorophosphate, 1-butyl-3-methyl-imidazolium hexafluorophosphate, 1-hexyl-3-methyl-imidazolium hexafluorophosphate, 1-butyl-4-methyl-pyridinium hexafluorophosphate, 1,3-dimethylimidazolium methylsulfate, 1-butyl-3-methyl-imidazolium methylsulfate, dimethylimidazolium triflate, 1-ethyl-3-methylimidazolium triflate, 1-butyl-3-methylimidazolium triflate, 1-butyl-3-ethylimidazolium triflate, or trihexyltetradecylphosphonium chloride. Examples of supercritical solvents include, for example, supercritical carbon dioxide, supercritical water, supercritical ammonia, or supercritical ethylene.

### Percolation Threshold:

The multifunctional nanomaterial-containing composites of the present embodiment have superior electrical or thermal conductivity, or superior mechanical properties as compared to other composites. One quantifiable measure of such improved properties is the percolation threshold of the composites. The percolation threshold is the minimum amount by weight or volume of nanomaterial present within the composite that provides interconnectivity within the composite. A low percolation threshold indicates good dispersion of nanomaterial within the composite. The percolation threshold is unique to the type of substrate, type of nanomaterial, type of reactive polymeric dispersing agent, and conditions of fabricating the composites. The percolation threshold is also unique to a particular property, i.e., a percolation threshold for an electrical property may be different from a percolation threshold for a thermal property for a particular composite since an electrical property enhancement mechanism is different from a thermal property enhancement mechanism.

Composites of the present embodiments have a percolation threshold for electrical conductivity, or a percolation threshold for thermal conductivity within a range of any of the following percentages: 0.01%, 0.02%, 0.04%, 0.05%, 0.075%, 0.1% 0.5%, 1.0%, 1.5%, 2.0%, 2.5%, 3.0%, 3.5%, 4.0%, 4.5%, 5.0%, 6%, 7%, 8%, 9%, 10%, 15% and 20% and 33% by weight or volume. In other embodiments, a percolation threshold for electrical conductivity or a percolation threshold for thermal conductivity is equal to or greater than 0.01%, 0.02%, 0.04%, 0.05%, 0.1% 0.5%, 1.0%, 1.5%, 2.0%, 3.0%, 4.0%, 5.0%, 10% and less than or equal to 20.0% by weight or volume. In further embodiments, a percolation threshold for electrical conductivity or a percolation threshold for thermal conductivity is equal to or greater than 0.01%, 0.02%, 0.04%, 0.05%, 0.1%, 0.5%, 1.0%, 1.5%, 2.0%, 3.0%, 4.0%, and less than or equal to 5.0% by weight or volume.

The following examples are presented to further illustrate various aspects of the present invention, and are not intended to limit the scope of the invention.

### EXAMPLE 1

### Synthesis of a Reactive Polymeric Dispersing Agent

The synthesis of a poly(phenyleneethynylene) reactive polymeric dispersing agent that comprises structure P_{d} as described above will now be described in the following paragraphs.

### Preparation of Monomer Portion “b”

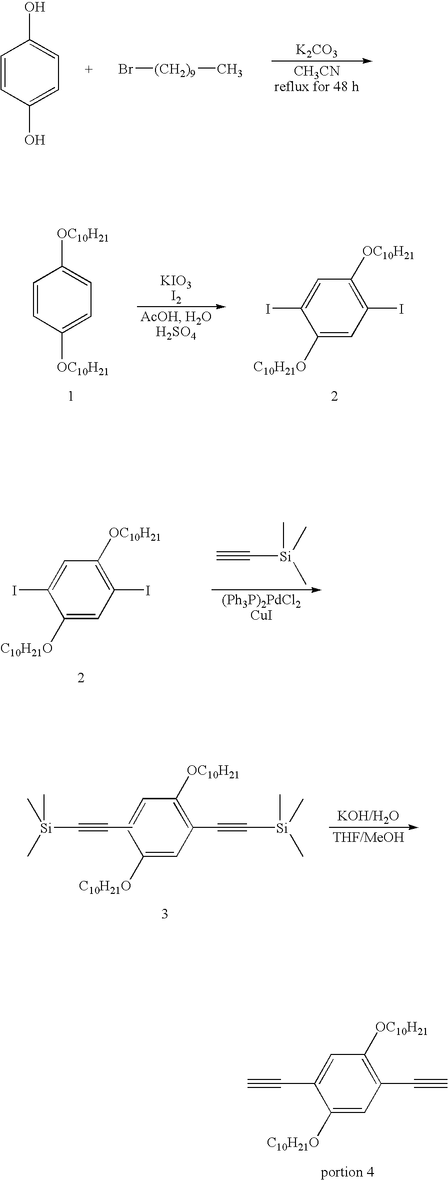

In the scheme indicated above, monomer portion 4 is an electron donating monomer and comprises the “b” monomer portion of the structure P_{d} as described above. Preparation of intermediates 1, 2 and 3 is now described.

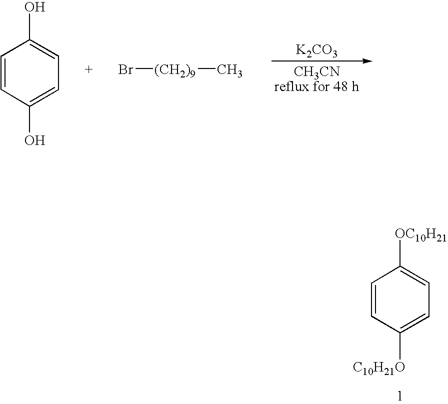

1,4-didecyloxybenzene (1): A 1-L, three-necked flask, equipped with a reflux condenser and mechanical stirrer was charged under argon atmosphere with 1,4-hydroquinone (44.044 g, 0.4 mol), potassium carbonate, K₂CO₃, (164.84 g, 1.2 mol), and acetonitrile (ACS grade, 500 mL). 1-Bromodecane (208.7 mL, 1.0 mol) was added and the reaction mixture was then heated to reflux under argon flow for 48 h. The hot solution was poured into an Erlenmeyer flask charged with water (1.5 L) and stirred with a magnetic bar stirrer to precipitate the product. The beige precipitate was then collected by filtration using a Buchner funnel with a fritted disc, washed with water (1.0 L), dried, and then dissolved in hot hexanes (ACS grade, 250 mL). The resulting hot hexanes solution was added slowly to an Erlenmeyer flask charged with ethanol (tech. grade, 1.5 L) and vigorously stirred to precipitate the product. The mixture was stirred for at least 2 h then the white precipitate was collected by filtration on a Buchner funnel equipped with a fritted disc, washed with cooled ethanol (tech. grade, 0.5 L), and dried under vacuum pressure for 12 h to give 151.5 g (97% yield) of a fluffy white solid. ¹H NMR (CDCl₃) δ6.83 (s, 4H), 3.92 (t, J=6.6 Hz, 4H), 1.73 (m, 4H), 1.45 (m, 4H), 1.30 (m, 22H), 0.91 (t, J=6.7 Hz, 6H).

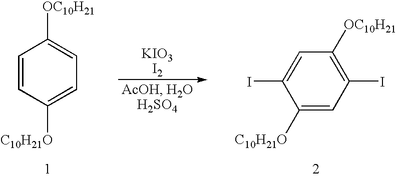

1,4-didecyloxy-2,5-diiodobenzene (2): A 1-L, two-necked flask equipped with a reflux condenser, and a magnetic bar stirrer was charged with potassium iodate, KIO₃, (15.20 g, 0.066 mol), iodine (36.90 g, 0.132 mol), acetic acid (700 mL), water (50 mL), and sulfuric acid (15 mL). 1,4-didecyloxybenzene (1) (51.53 g, 0.132 mol) was added to the solution and the reaction mixture was then heated to reflux for 8 hours. The purple solution was allowed to cool to room temperature under constant agitation and a saturated aqueous solution of sodium thiosulphate (100 mL) was added until the brown iodine color was gone. The beige-brown precipitate was collected by filtration using a Buchner funnel equipped with a fritted disc, washed with water (700 mL), ethanol (500 mL), and dried. This solid was then dissolved in hot hexanes (300 mL). The resulting hot hexanes solution was poured slowly into an Erlenmeyer flask charged with ethanol (1.5 L) and vigorously stirred to give a white precipitate. This precipitate was collected by filtration, washed with ethanol (1.0 L), and dried under vacuum overnight to give 78.10 g (92% yield) of pure white solid. ¹H NMR (CDCl₃) δ7.21 (s, Ph, 2H), 3.94 (t, J=6.4 Hz, OCH₂, 4H), 1.82 (m, CH₂, 4H), 1.47 (m, CH₂, 4H), 1.29 (m, CH₂, 22H), 0.90 (t, J=6.72 Hz, CH₃, 6H). ¹³C NMR (CDCl₃) d 152.8, 122.7, 86.2, 70.3, 31.9, 29.5, 29.3, 29.2, 29.1, 26.0, 22.6, 14.1.

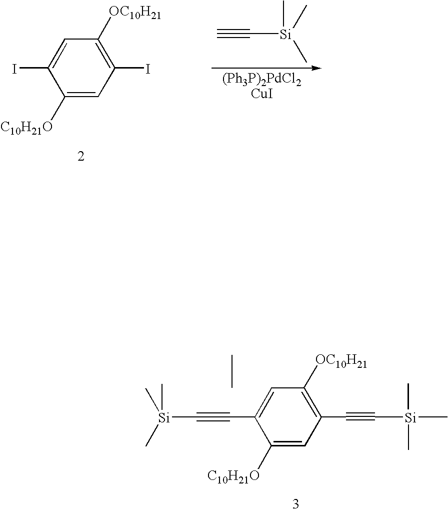

1,4-didecyloxy-2,5-bis-(trimethylsilylethynyl)benzene (3): To a degassed 1.5 L of diisopropylamine was added 1,4-didecyloxy-2,5-diiodobenzene (2) intermediate (100.0 g, 0.1557 mol), CuI (1.48 g, 0.00778 mol), dichlorobis(triphenylphosphine)palladium(II) (5.46 g, 0.00778 mol). The reaction mixture was stirred for 10 minutes and trimethylsilylacetylene (48.4 mL, 0.342 mol) was added slowly over 15-30 minutes at room temperature. The diisopropylammonium salts are formed during the addition and at the end of the addition the solution turned dark brown. After the addition was completed, the reaction mixture was stirred at reflux for 8 h. After cooling, the mixture was diluted with hexanes (500 mL) and filtered through a 4 cm plug of silica gel. The solvent was removed and the product was precipitated from chloroform/EtOH (1:5, 1.5 L). The solid was filtered, washed with water (250 mL), washed with EtOH (250 mL) and dried to give 81.8 g of the desired product as a white solid. Yield (91%). ¹H NMR (CDCl₃) δ6.85 (s, Ph, 2H), 3.93 (t, J=6.4 Hz, OCH₂, 4H), 1.78 (m, CH₂, 4H), 1.27 (m, CH₂, 22H), 0.88 (t, J=6.42 Hz, CH₃, 6H), 0.26 (s, 18H). ¹³C NMR (CDCl₃) d 154.0, 117.2, 113.9, 101.0, 100.0, 69.4, 31.9, 29.6, 29.5, 29.4, 29.3, 26.0, 22.6, 14.1, 0.17.

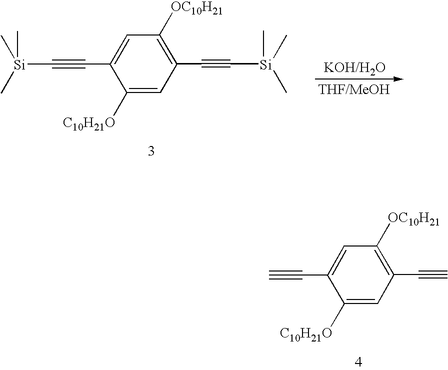

1,4-Diethynyl-2,5-didecyloxybenzene (4): 200 mL of methanol and 120 mL of 20% KOH were added to a rapidly stirred solution of 1,4-didecyloxy-2,5-bis(trimethylsilylethynyl)benzene (80.0 g, 137.21 mmol) in THF (500 mL) at room temperature. The reaction mixture was stirred overnight. The THF was then removed under reduced pressure and the residue was diluted with EtOH (400 mL). A pale yellow solid was filtered, washed with EtOH (250 mL), and dried to give 60.05 g of monomer portion 4 as a pale yellow product. Monomer portion 4 is the “b” monomer portion of the structure P_{d} as described above. Yield (99.7%). ¹H NMR (CDCl₃) δ6.96 (s, Ph, 2H), 3.98 (t, J=6.58 Hz, OCH₂, 4H), 3.34 (s, CCH, 2H), 1.82 (m, CH₂, 4H), 1.52 (m, CH₂, 4H), 1.31 (m, CH₂, 22H), 0.88 (t, J=6.71 Hz, CH₃, 6H). ³C NMR (CDCl₃) d 153.9, 117.7, 113.2, 82.4, 79.7, 69.6, 31.9, 29.5, 29.3, 29.1, 25.9, 22.6, 14.1.

### Preparation of Monomer Portion “a”

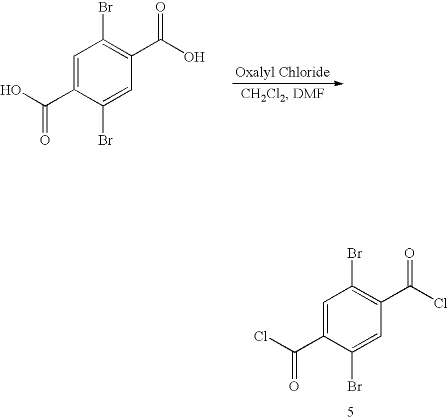

2,5-dibromobenzene-1,4-dioyl dichloride (5): Oxalyl chloride (108.6 mL, 1.244 mol) was added slowly at room temperature and under argon flow to a suspension of 2,5-dibromobenzene-1,4-dicarboxylic acid (168.0 g, 0.518 mol) in dichloromethane. A few drops of dry DMF were added and the reaction mixture was stirred for 10 minutes then heated to reflux for 12 h. ½ of the dichloromethane was removed under pressure and hexanes (500 mL) was added. The pale yellow precipitate was recovered by filtration, washed with hexanes (250 mL) and dried under vacuum overnight to give 185.00 g (98.8% yield).

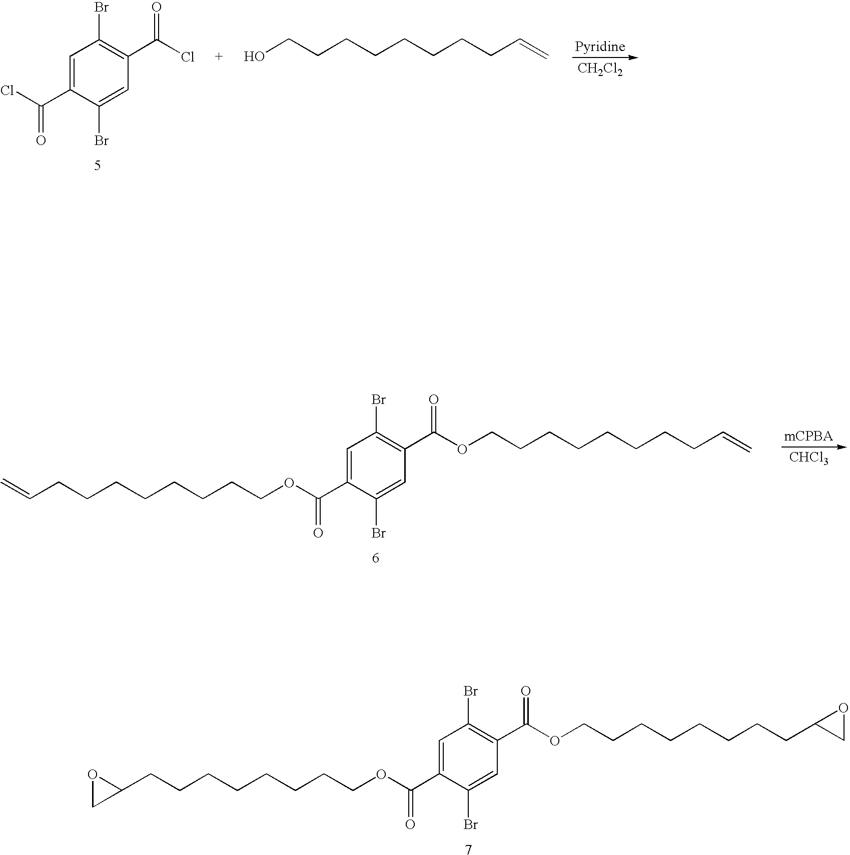

To a solution of 10-undecene-1-ol (100 gm, 0.293 mol), and pyridine (70 g, 0.88 mol) in dichloromethane (500 mL) at 5° C. and under argon, was added slowly a solution of 2,5-dibromobenzene-1,4-dioyl dichloride 5 (105 g, 0.29 mol) in THF (250 mL) for about 30 minutes. The reaction mixture was then allowed to warm to room temperature and stirred for 8 hrs. The reaction mixture was concentrated using a rotary evaporator and the residue was recrystallized in ethanol (250 mL) to precipitate the product. Then the reaction mixture was cooled to 5° C. for 30 minutes and filtered to obtain 180 gm of the intermediate 6 at an 89% yield. To a solution of intermediate 6 (104 gm, 165 mmol) in chloroform (500 mL) cooled to 0-4° C., metachloroperbenzoic acid (“mCPBA”), (130 g, 75% 564 mmole) was dissolved in chloroform (500 mL) and the metachlorobenzoic acid which is insoluble in chloroform precipitated out. The chloroform solution of mCPBA was transferred into an addition funnel and added to the reaction mixture slowly at 0° C. over a period of 15 minutes. The reaction mixture was stirred at 0-4° C. for 2 hrs during which chlorobenzoic acid precipitated out. The ice water bath was then removed and the reaction mixture was stirred at room temperature for 12 hrs. The reaction mixture was filtered and the filtrate was concentrated to yield a solid. The solid was transferred to methanol (250 mL) and stirred for 30 minutes, cooled to 5° C. and filtered to obtain 80 gm of monomer portion 7 as a solid (yield: 73%). Monomer portion 7 is the “a” monomer portion of the structure P_{d} as described above.

### Preparation of Monomer Portion “c”

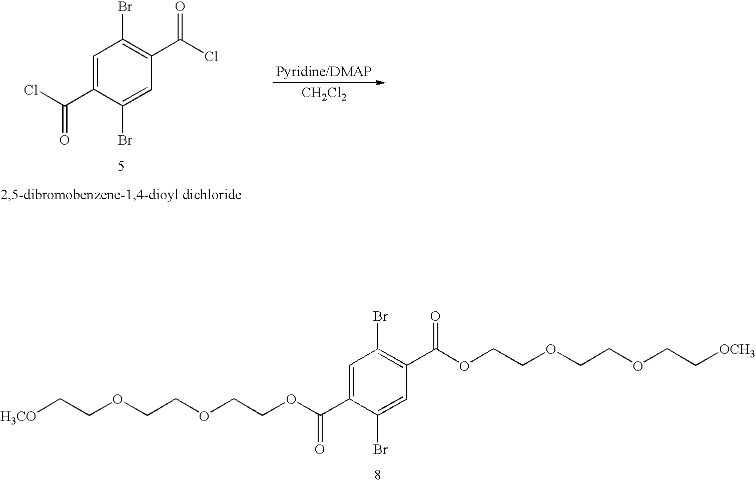

### Bis(2-(2-(2-methoxyethoxy)ethoxy)ethyl) 2,5-dibromobenzene-1,4-dioate (8)

A three necked 5 L round bottomed flask equipped with nitrogen inlet, mechanical stirrer and addition funnel was charged with triethylene glycol monomethyl ether (455 g, 2.77 mol), pyridine (329 g, 4.15 mol), 4-dimethylaminopyridine (“DMAP”) (4.23 g, 34.6 mmol) and CH₂Cl₂ (1.0 L) to form a reaction mixture. The reaction mixture was then cooled to 4° C. with a gentle purge of nitrogen. A solution of 2,5-dibromobenzene-1,4-dioyl dichloride (500 g, 1.38 mole) in THF (500 mL) was transferred into the addition funnel. The THF solution was then slowly added under nitrogen over a period of 1.0 hrs at 4° C. The reaction was allowed to warm to room temperature and stirred for an additional 12 hrs at room temperature during which a white precipitate formed. The mixture was filtered to remove the precipitate. The filtrate was washed with 1000 mL of (50% aq. HCl) followed by 1000 mL of (20% aq. K₂CO₃), 1000 mL of brine and finally 2×1000 mL of water. The organic solution was dried over Na₂SO₄ (100 g) and concentrated to obtain 750 gm of monomer portion 8 as a solid (yield: 87%). Monomer portion 8 is the “c” monomer portion of the structure P_{d} as described above.

An exemplary polymerization of monomer portions “a”, “b” and “c” will now be described in which the donor/acceptor monomer portion ratio is 1:1.

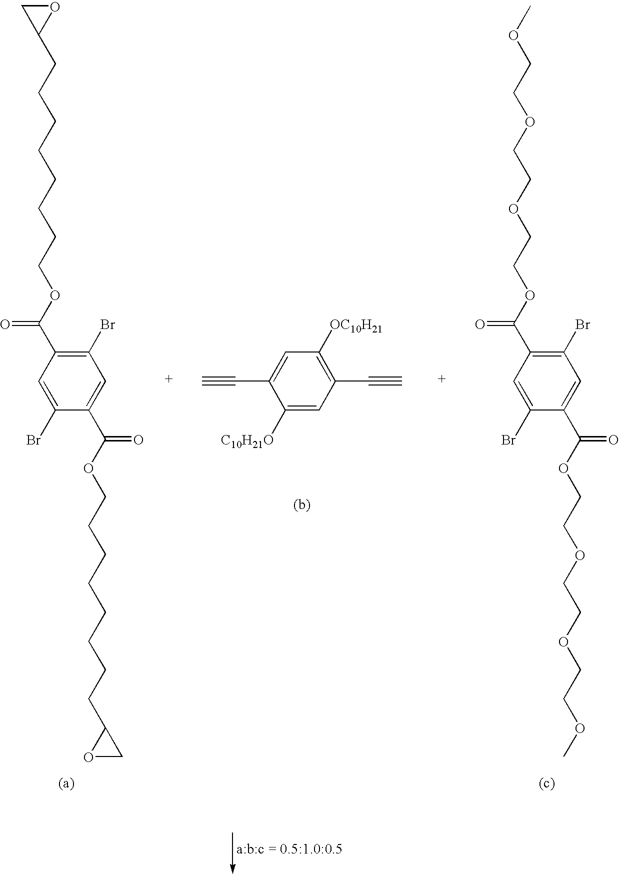

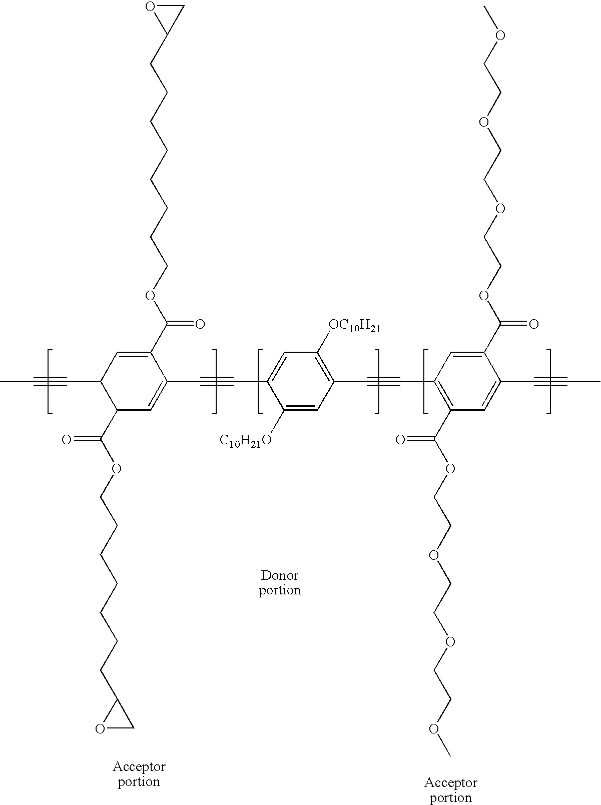

### Synthesis of PPE Having a Donor/Acceptor Monomer Portion Ratio of 1:1

A 2000-mL, oven dried two-necked flask, equipped with a reflux condenser, and magnetic bar stirrer was charged with toluene/diisopropylamine (4:1; 1100 mL) and was degassed at room temperature by constant argon bubbling for 3 h. Monomer portion “a” (28.8 g., 45.6 mmol), monomer portion “b” (40 g., 91.2 mmol) and monomer portion “c” (28.1 g., 45.6 mmol) were added to a degassed mixture of toluene/diisopropylamine. Palladium tetrakis triphenylphosphine (Pd(TPP)₄) (1.89 g., 1.64 mmol) and CuI (1.66 g., 8.75 mmol) were then added under nitrogen to the reaction mixture and heated to 30-60° C. for 4-12 hrs. The resultant PPE polymer was precipitated into ethanol and was isolated by filtration.

### EXAMPLE 2

### Production of Polyethylene Fabric Coated with Carbon Nanotubes

0.25 g. of powdered PPE from Example 1, was added to 100 ml. of methylene chloride solvent which is commercially available from Sigma Aldrich and sonication was carried out for 5 minutes and the temperature was kept below 30° C. to prevent the methylene chloride from evaporating.

Next, 12 g. of multi-wall carbon nanotubes obtained from Arkema-France having average tube dimensions of about 30-50 nm in diameter and 30 μ in length were sonicated in methylene chloride for 2 minutes. Then the sonicated carbon nanotube solution was mixed with the PPE and methylene chloride solution to form a dispersed carbon nanotube solution. The dispersed carbon nanotube solution was then filtered to remove impurities using a Spectrum® fine mesh filter having a mesh opening of about 51μ obtained from Spectrum Labs.

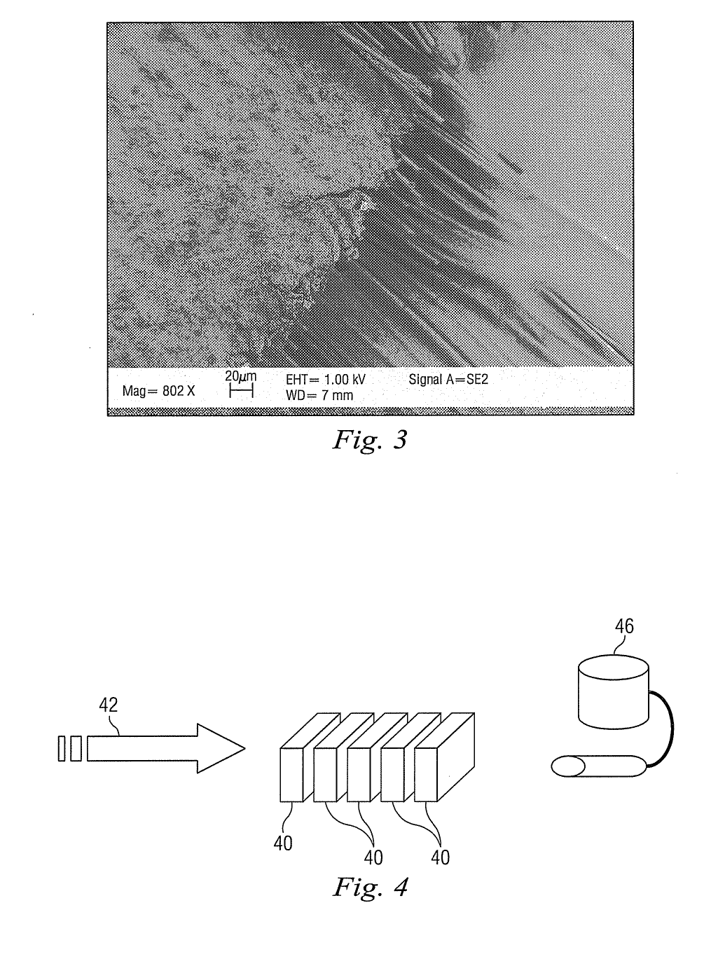

Polyethylene fabric coupons having a size of approximately 12″×12″ square were prepared from an ultra-high molecular weight polyethylene fabric that is commercially available under the trademark Spectra® from Good Fellow Corporation. Such fabric had a 215 yarn denier and a plain weave. The fabric coupons were then coated with the dispersed carbon nanotube solution by first dipping the fabric coupons in the filtered dispersed carbon nanotube solution to assist the carbon nanotubes in coating the fabric by a wicking process. Each fabric coupon was then removed from the dispersed carbon nanotube solution and the filtered dispersed carbon nanotube solution was then spray-coated onto both sides of the polyethylene fabric coupons using an FX-100 Mini HVPL spray gun obtained from Sharpe Manufacturing and dried immediately using a Fisher Varitemp, Model HG-201-A hot air gun operating at 100° F. The methylene chloride evaporated immediately thus leaving the carbon nanotubes on the polyethylene fabric coupons. FIG. 3 shows carbon nanotubes coated on polyethylene fabrics.

### EXAMPLE 3

### Production of a Carbon Nanotube-Reinforced Epoxy Matrix

A mixture was formed by adding 100 ml. of the dispersed carbon nanotube solution prepared according to Example 2 to 105 g. of L 285 epoxy resin which is commercially available from Aircraft Spruce & Specialty Co., Corona, Calif. The mixture was mixed using a high shear mixer operating at 8000 rpm for 3 minutes and the temperature of the vessel was maintained at 100° F. using an ice bath. The viscosity of the epoxy increased significantly from 800 cps to 1500 cps after the addition of the dispersed carbon nanotube solution, and the vessel was shaken frequently to achieve proper mixing. High shear mixing was used to achieve primary consolidation of the epoxy resin and the dispersed carbon nanotubes. Because long shear times tend to degrade the epoxy resin and do not efficiently disperse the carbon nanotube solution in the epoxy resin, further mixing or dispersion was achieved by three roll mill mixing using an EXAKT E 80 three roll mill available from EXAKT Technologies, Inc. Three roll mill mixing involves less shear and more elongation flow and helps to disperse the carbon nanotubes very uniformly in resin when compared to high shear mixing. Table I below shows the conditions used on the three roll mill to disperse the carbon nanotube solution in the epoxy L 285 resin.

TABLE I

| Epoxy resin | | Nip | Nip | | | |
|---|---|---|---|---|---|---|
| 3.0% vol | | distance | distance | speed rpm | | |
| MWNTs | Viscosity | roller | roller | 1st | 2nd | 3rd |
| Passes | (cps) @ 77° F. | 2 & 3 | 2 & 1 | roller | roller | roller |
| 0 | 1500 | | | | | |
| 1 | 1800 | 20 | 20 | 44 | 133 | 400 |
| 2 | 2550 | 15 | 15 | 44 | 133 | 400 |
| 3 | 3700 | 10 | 10 | 44 | 133 | 400 |
| 4 | 5210 | 5 | 5 | 44 | 133 | 400 |
| 5 | 6400 | 5 | 5 | 44 | 133 | 400 |
| 6 | 7625 | 5 | 5 | 44 | 133 | 400 |
| 7 | 7650 | 5 | 5 | 44 | 133 | 400 |

As noted in Table I, by passing the mixture of the dispersed carbon nanotubes and the epoxy resin through the three roll mill seven times, the viscosity of the mixture increased significantly. Without being bound to any theory expressed herein, it is believed that such viscosity increase is due to the fact that more solvent evaporates with each pass through the rollers and the dispersion of the carbon nanotubes consequently improves.

### EXAMPLE 4

### Production of a Carbon Nanotube/Polyethylene/Epoxy Composite

The coated polyethylene fabric coupons from Example 2 were placed on a Teflon plate and the carbon nanotube-reinforced epoxy from Example 3 was applied evenly on both sides of the fabric coupons using a brush. Each of the epoxy coated fabric coupons were stacked on top of each other and placed on a compression molding machine. This method of composite manufacture is referred to as a “leaky mold approach”. The compression pressure to make composite blocks from multiple layers of epoxy coated fabric coupons was less than a metric ton and the temperature was about 100° C. Voids were minimized by vacuum degassing, addition of pressure and voids-eliminating chemicals. For radiation experiments discussed in Examples 5 and 6, the sample size of the composite blocks was targeted to be around 10 cm×10 cm×1 cm, and multiple testing samples (e.g. 5 pieces of samples) were stacked and used in one radiation experiment to meet the thickness requirement. For comparison, a carbon nanotube free polyethylene/epoxy composite was also fabricated under similar conditions.

The following volume fractions were used for fabricating the test coupons and were also chosen to fit the radiation coupon requirements (constant density thickness across all the coupons):
Volume of polyethylene=54%
Volume of carbon nanotubes=3% (from coating of polyethylene)
Volume of carbon nanotubes=3% (from incorporation in epoxy matrix)
Volume of Epoxy=40%

Thinner sheets of composites which were about 3mm or ⅛″ in thickness were also made. The sheet composites were also made using the same volume fractions and methods that were used for the composite blocks.

### EXAMPLE 5

### Radiation Shielding Effectiveness of Carbon Nanotube/Polyethylene Composites

The radiation shielding effectiveness of the carbon nanotube/polyethylene composite was evaluated for its radiation shielding effectiveness against both galactic cosmic ray (“GCR”) and solar particle event (“SPE”) simulated beams. The carbon nanotube/polyethylene composites in sheet form were radiated with a highly degrading beam to study the effects of radiation on its physical properties.

To perform shielding experiments, two sets of epoxy/polyethylene composite samples were prepared:

1. Set one utilized carbon nanotubes in the matrix materials and was black in color (“carbon nanotube composite”).

2. Set two was a neat composite which had no carbon nanotubes and was white in color (“neat composite”).

Five sample slabs having a size of approximately 10 cm×10 cm×1.4 cm of each type was provided for radiation shielding experiments.

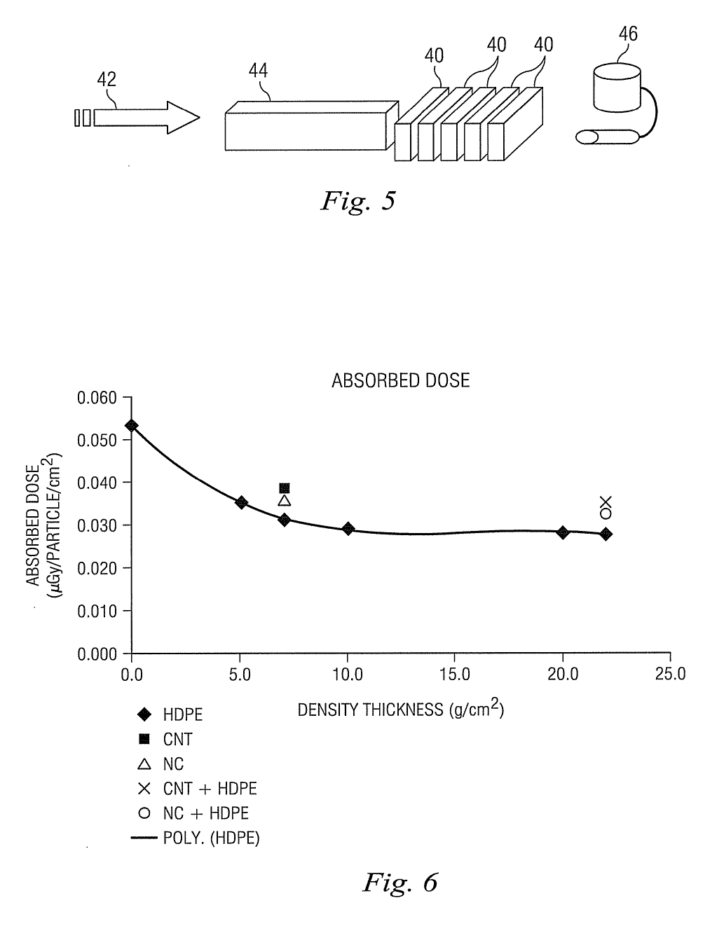

The heavy ion used for the radiation shielding experiments was Fe⁵⁶ at an energy of 1000 MeV/nucleon (“1000 MeV/n”). This ion is very penetrating and suitable for shielding experiments for relatively thick targets. Because of this, two types of radiation shielding experiments were designed and are shown schematically in FIGS. 4 and 5. In the configuration shown in FIG. 4, five sample slabs 40 were placed in the 1000 MeV/n Fe⁵⁶ beam 42 simultaneously so that beam shielding was measured relative to having no material in the beam. The combination of the five slabs had a density thickness of approximately 7 g/cm². Even with this density thickness, model calculations showed that the 1000 MeV/n Fe⁵⁶ ions would easily penetrate the stack. Based on these calculations, the configuration shown in FIG. 5 was designed so that a 15 g/cm² high density polyethylene block 44 would effectively degrade the beam 42 and so the shielding properties of the carbon nanotube composite and neat composite samples could be better measured. The high density polyethylene block 44 essentially changed the linear energy transfer (LET) value of the iron beam so that more energy would be deposited in the carbon nanotube composite and neat composite slabs, thus highlighting the shielding properties of these materials.

The tissue equivalent proportional counter (TEPC) 46 shown in FIGS. 4 and 5 was used to measure radiation dosimetry. The TEPC measures the radiation quantities of absorbed dose and dose equivalent to a small volume of human tissue. The TEPC instrument used is functionally identical to the active radiation dosimeters used on the space shuttle and the International Space Station (ISS).

In all, six experimental “runs” were performed during this set of experiments. The thrust of all six runs was to compare the relative shielding ability of the carbon nanotube composite and neat composite samples with each other and then with polyethylene. The runs are described as follows:

1. All 5 carbon nanotube (CNT) composite slabs (˜7 g/cm²).

2. All 5 neat composite (NC) slabs (˜7 g/cm²). An experiment to compare the shielding ability of the material without the carbon nanotubes.

3. Polyethylene slab with the same density thickness as either the carbon nanotube (CNT) composite or the neat composite (NC) targets, i.e. (˜7 g/cm²). The data from this experiment enables a comparison of the radiation shielding effectiveness of the nanocomposites with an equivalent density thickness of high density polyethylene.

4. All 5 carbon nanotube (CNT) slabs plus 15 g/cm² polyethylene (HDPE).

5. All 5 neat composite (NC) slabs plus 15 g/cm² polyethylene (HDPE).

6. Polyethylene slab with the same density thickness as the carbon nanotube (CNT) or the neat composite (NC) targets (˜7 g/cm²) plus 15 g/cm² polyethylene (HDPE).

The data obtained during the experimental runs described above is shown in graphical form in FIG. 6. FIG. 6 shows the absorbed dose data for the carbon nanotube composite (CNT) and neat composite (NC) samples in the configurations described in this example and shown in FIGS. 4 and 5 compared to a shielding curve for high-density polyethylene (HDPE). The absorbed dose is a measure of the amount of energy absorbed from the radiation per unit mass (in this case, equivalent to human tissue). The units on the figure are normalized by the number of particles per unit area of the incident beam. The data in FIG. 6 shows that the carbon nanotube composite and neat composite samples compare favorably to HDPE, with the differences being close to the experimental error of the instrumentation (about 8%).

Thus, the carbon nanotube composites demonstrated shielding properties similar to high density polyethylene. These results demonstrate that the carbon nanotube composites materials of the present embodiments would be useful for radiation shielding and other purposes on an interplanetary spacecraft.

### EXAMPLE 6

### Proton Shielding Effectiveness of Carbon Nanotube/Polyethylene Composites

The material degradation of heavy ions on the composites was evaluated using twenty “dogbone” composite samples, ten neat composite samples without carbon nanotubes and ten carbon nanotube composite samples. These samples were exposed to 300 MeV/n Fe⁵⁶ ions to a dose of 3000 Rad. This dose was chosen to be commensurate with the expected radiation dose for a relatively long space mission (on the order of years). Because of the relatively low energy of these ions, they have a substantially higher linear energy transfer value than the 1000 MeV/n Fe⁵⁶ ions used in the shielding experiments of Example 5. Therefore, this ion represents a “worst case” component of the galactic cosmic ray spectrum, with a high energy deposition for a given exposure. This experiment is a “point and shoot” type with characterization of the samples performed after exposure. Significant changes were observed in the mechanical properties of the carbon nanotube composite samples due to the radiation exposure. Based on the results of the degradation experiment, it appears that space radiation may “age” spacecraft including the carbon nanotube composites in a positive way.

The results of the proton experiments are summarized in Table II below:

TABLE II

| | Measured Proton Threshold |
|---|---|
| Samples | Energy (MeV) |
| Neat Composite (White) | 41.71 ± 0.02 |
| Carbon Nanotube Composite (Black) | 41.11 ± 0.02 |

The results show that the two samples have virtually identical results in terms of proton stopping power.

The threshold energy represents the highest energy proton completely shielded (stopped) by the material. The significance of these results is most relevant to protons that originate from the sun, including SPE protons.

The proton data show that even a relatively thin layer of the carbon nanotube composites will stop protons up to about 42 MeV in energy. The addition of the carbon nanotubes does not degrade this ability. The energy value represents a significant part of the solar proton spectrum that the composites would shield.

### EXAMPLE 7

### Physical Properties of Carbon Nanotube/Polyethylene Composite Before and After Radiation Exposure

The following physical properties of the composite samples were analyzed before and after radiation exposure to highly charged energetic heavy ions (such as iron ions) known as HZE particles: tensile modulus, electrical properties (conductivity) and EMI.

The electrical conductivity of the samples was measured by a four point probe method to prevent contact resistance and also with a two point probe method. According to the four point probe method, the probes were straight in line and located equidistant from each other. A constant current was passed through the 2 outer probes and the voltage was measured across the 2 inner probes. Ohm's law was applied along with the area to calculate the conductivity of the samples.

According to the two probe method, two sizes of samples were selected and the surfaces of the samples were polished with a diamond wheel. Polished surfaces were cleaned using acetone-dipped cotton. Cleaned surfaces were observed under an optical microscope for any impurity. Commercially available low viscosity silver epoxy was coated on the cleaned polished surfaces by screen printing and dried in a vacuum oven at 50° C. for 1 hr. After drying, silver foil was bonded on top of dried silver epoxy using silver gel prepared by mixing silver powder into commercially available conductive epoxy. Again the samples were dried at 50° C. for 30 minutes. A Hewlett Packard 34401A digital multi-meter was used for measuring the resistance across the electrode area. As will be understood by those of ordinary skill in the art, the electrical resistivity was determined by multiplying the measured resistance by the area of the electrodes and dividing this product by the distance between the electrodes.

The electrical conductivity of the composite samples with and without carbon nanotubes is set forth in Table III:

TABLE III

| | Multi-walled | Multi-walled | | | Electrical | Electrical |
|---|---|---|---|---|---|---|
| | carbon nanotubes/ | carbon | polyethylene | | resistivity | resistivity |
| | polyethylene | nanotubes/ | Fiber Fabric | Epoxy | (in-plane) | (out-of-plane) |
| Samples | (vol %) | Epoxy (vol %) | (vol %) | (vol %) | (Ω-cm) | (Ω-cm) |
| 1 | 0 | 0 | 49 | 51 | 10¹⁴ | 10¹⁴ |
| 2 | 3.1 | 3.1 | 50.1 | 43.7 | 56.73 | 52.86 |

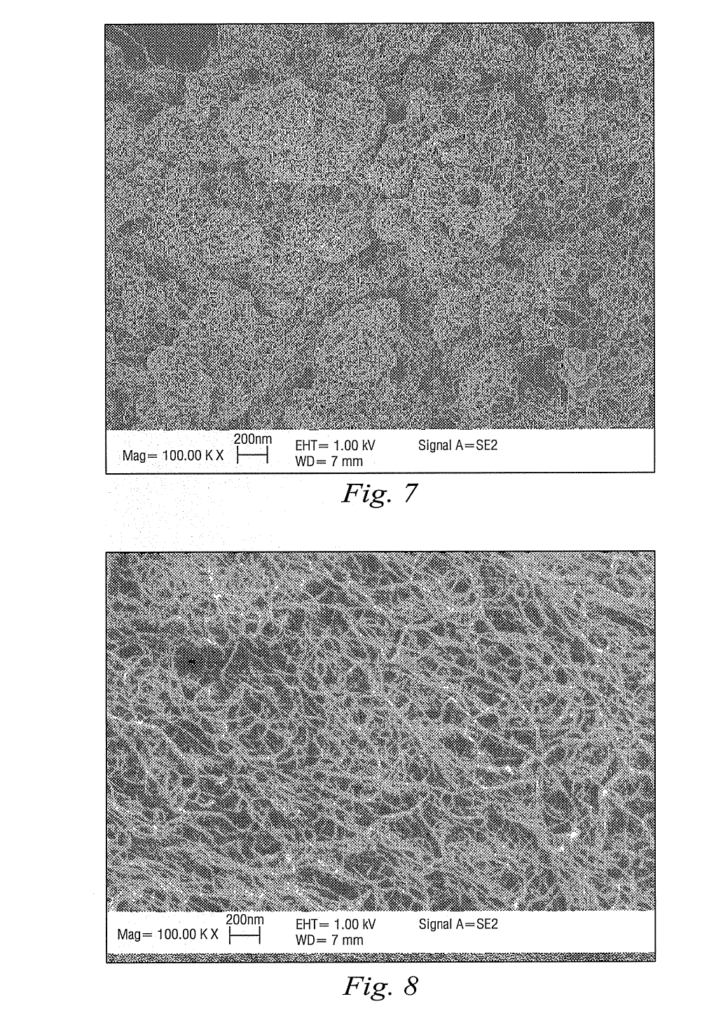

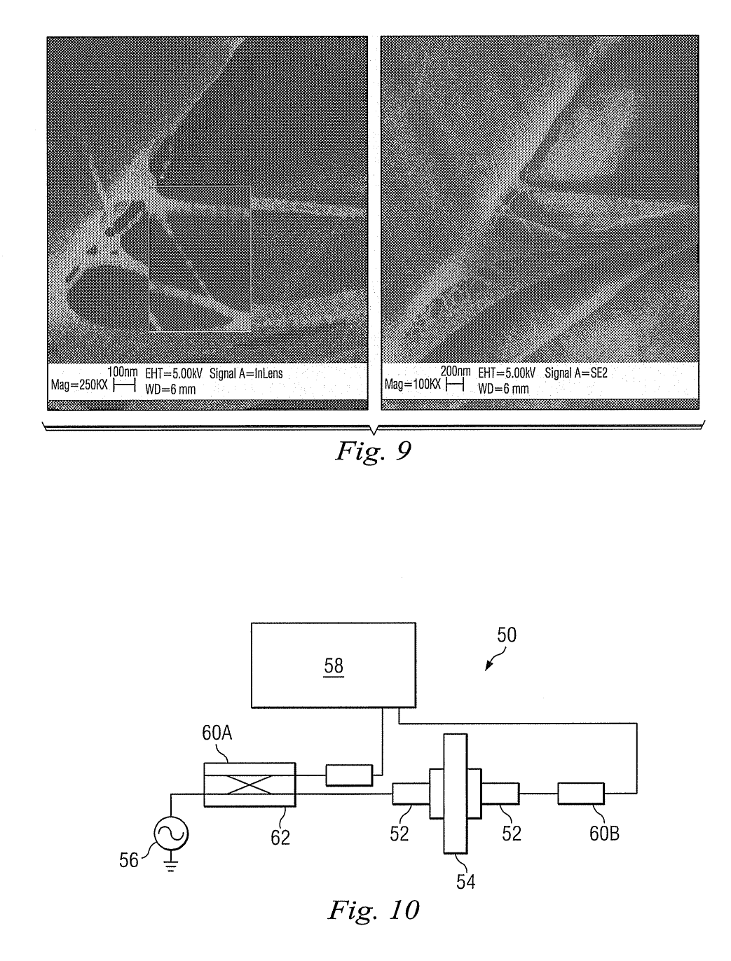

The data shown in Table III demonstrate that a high electrical conductivity was achieved with a relatively low loading of only about 6% of carbon nanotubes by volume of the composite. It is believed that such high levels of conductivity were achieved because of the excellent dispersion of the carbon nanotubes which leads to high percolation networks in the composites. This in turn leads to achieving the percolation threshold at lower loading levels. The extensive carbon nanotube networks formed can also be visually seen in the SEM images shown in FIGS. 7, 8 and 9. FIG. 9 shows SEM images of the composite exhibiting crack bridging properties leading to improved mechanical and electrical properties. The right-hand image in FIG. 9 shows a crack wall in which carbon nanotubes are oriented perpendicular to the wall, which is a typical phenomenon in crack bridging. The multi-walled carbon nanotubes broke or slipped which led to the absorption of more energy before the matrix was destroyed. Carbon nanotubes exhibiting crack bridging properties provide reinforcement to the matrix.

EMI shielding effectiveness testing was performed with an approach similar to the American Society for Testing Material's Test No. ASTM D4935-99 for performing EMI tests. Specifically, the shielding effectiveness of the nanocomposites of the present embodiments was measured by taking RF measurements with the apparatus 50 shown schematically in FIG. 10 which consisted of a test fixture 52 bolted onto the test sample 54, an HP89592B, 20 MHz-2 GHz signal source 56, a scalar network analyzer 58 and HP11664A detectors 60A and 60B to measure reflection and transmission of an RF signal though the text fixture 52 and the test sample 54. Test frequencies ranged from 20 MHz to 2 GHz at a power level of approximately 14 dBm. Power measurements yielded RF insertion loss, which is a direct measure of the shielding effectiveness. Reflection measurements using an NP 85021C directional bridge 62 also provided reflection information, allowing calculation of the reflection portion of the shielding.

The insertion loss which is a direct measurement of the EMI shielding effectiveness of the samples was at or near the noise floor of the test system due to the fixture design and analyzer dynamic range (˜50 dB). The carbon nanotubes composite sample exhibited a minimum of 50 dB shielding effectiveness over the frequency range of interest which represents a minimum of shielding effectiveness for the samples.

The measured reflected energy (return loss) of the test setup provided insight into the portion of the shielding effectiveness due to reflection. The measured return loss was converted into a reflection coefficient, which was then used to calculate the reflected portion of the shielding effectiveness. This portion of the shielding effectiveness was impacted by the conductivity and dielectric constant of the sample. The remaining portion of the shielding effectiveness was due to absorption which is a function of the attenuation constant of the sample material.

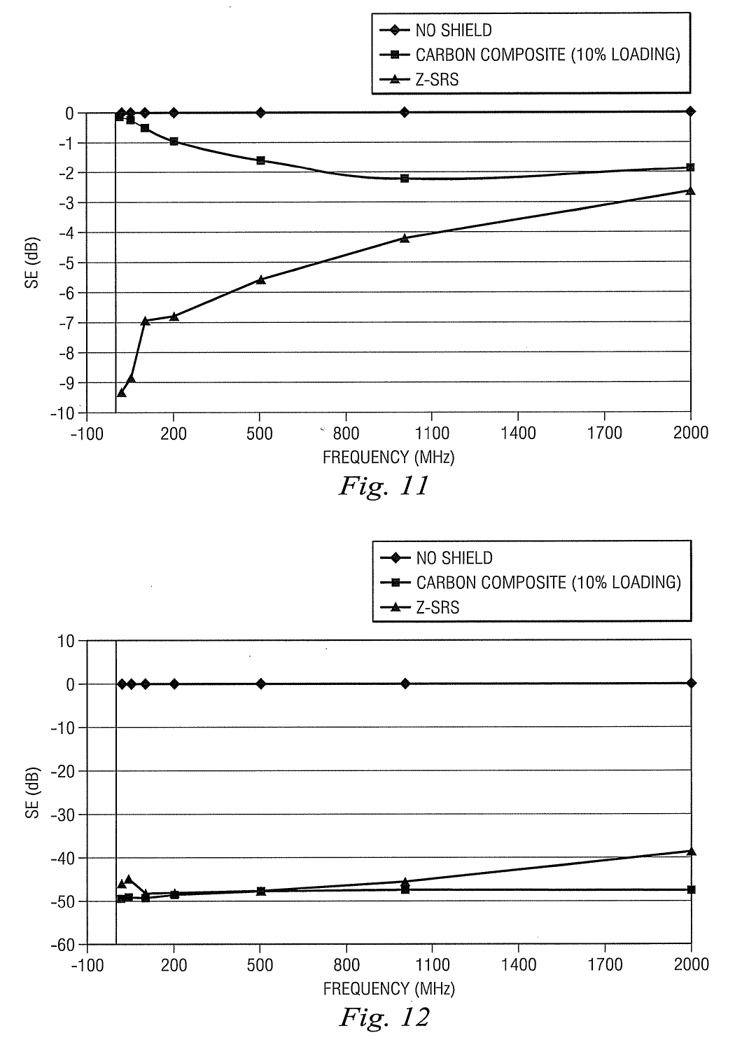

The results are shown in FIG. 11 which depicts shielding effectiveness due to reflection and FIG. 12 which depicts shielding effectiveness due to absorption. Together FIGS. 11 and 12 demonstrate that most of the shielding effectiveness is due to absorption in the composite rather than due to reflection from the surface.

It is believed that the maximum EMI shielding effectiveness of the composites should be very high. Shielding effectiveness (“SE”) is a function of the electrical conductivity of the material, as shown by the following equation:

SE=50+10 Log (σf)⁻¹+1.7 t(f/σ)^{1/2}

σ=resistivity (Ohm Cm), f=frequency (MHz), t=thickness of samples (cm).

Inserting the measured resistivity and thickness of the fabricated samples, it is expected that these materials will have a shielding effectiveness of approximately 50 dB. This correlates with the measured data.

Scanning Electron Microscopy Image Analysis (SEM) was conducted using a LEO SEM. In order to perform the SEM analysis, a layer of gold was deposited on all the samples with 1.5-2 nm of gold using an evaporator. A very low voltage between 0.9-1.5 kV was used for imaging to prevent any charging in the samples.

Overall the samples were found to have large surface defects which may be attributable to the processing method of the composites. The unradiated carbon nanotube composites showed a larger number of defects compared to all the other composites. In general, the radiation of the composites (due to the high degrading nature of the beam—a dose of 3000 Rad of a 307 MeV/nucleon beam), tended to reduce the number of defects in the samples, probably because of the cross-linking of the polymer by the beam. The radiated neat composites also showed a large amount of reduction in defects due to cross-linking. It was concluded from the images that the radiation induced changes in the composites are fairly large.

Mechanical testing was performed using an Instron Universal Testing Machine (5500 Series) with a 30 kN load cell and clip on strain gauge. All the tests were performed in tensile mode. All the samples were taken from the sheet composites. The testing and sample specifications were as follows:

Tensile Testing conditions-Test Method: ASTM 3039

| | |
|---|---|
| Crosshead Speed (in/min) | 0.2165 |
| Full Scale Load (lbf) | 6744.27 |
| Temperature (Deg F.) | 73 |
| Humidity (%) | 50 |
| Series IX version | 8.25.00 |
| Method | 82 |
| Ext. gauge length (in) | 0.98425 |
| Spec gauge length (in) | 3.13425 |

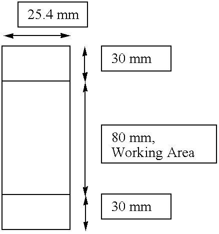

Five samples were tested and their average is repo [symbol] were as follows:

1. Neat composite unradiated (NC-Unrad);

2. Carbon nanotube composite unradiated (CNT-Unrad);

3. Neat composite radiated (NC-Rad); and

4. Carbon nanotubes composite radiated (CNT-Rad).

The tests were performed for two sets of beams to study the effect of beam strength on the composites. The degradation beams were Si 600 MeV and Fe 307 MeV.

The tensile test data are shown in Table IV. The samples were exposed to 307 Fe⁵⁶ MeV/nucleon ions to a dose of 3000 Rad.

TABLE IV

| Material | Modulus (Mpa) | % Change |
|---|---|---|
| Pure ultra high molecular weight | 1200 | N/A |
| polyethylene Sheet | | |
| Unradiated-Neat Composite | 1787 | 0 |
| Radiated-Neat Composite | 2882 | 61 |
| Unradiated-Carbon Nanotube Composite | 2422 | 36 |
| Radiated-Carbon Nanotube Composite | 2403 | 34 |

All the composites perform better in tensile modulus compared with the ultra high molecular weight polyethylene sheets. This is believed to be due to the oriented crystals in the composites (fibers).

The tensile modulus of the carbon nanotube composite and the radiated neat composite is higher than the unradiated neat composite. This shows the stiffening properties of carbon nanotubes and radiation.

The tensile modulus of the radiated neat composite increased by 61% compared to the unradiated neat composite. This is believed to be due to the cross-linking of the polyethylene and epoxy interface. The radiation is believed to oxidize the hydrogen atoms of the polyethylene to groups that are more hydrophilic which leads to better bonding with the epoxy at their interface.

By adding the carbon nanotubes to the composite (unradiated neat composite vs. unradiated carbon nanotube composite) the tensile modulus increased by 36%. One possible reason may be that the addition of carbon nanotubes acts as an effective reinforcement as shown in FIG. 9. Also, if the carbon nanotube composites are radiated, the tensile modulus does not change as much compared to the unradiated carbon nanotube composites.

The foregoing has outlined features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A process for preparing a multifunctional nanomaterial-containing composite, comprising:
(a) preparing a solution of dispersed nanomaterials comprising nanomaterials, a reactive polymeric dispersing agent for non-wrapping non-covalent functionalization of the nanomaterials and a solvent;
(b) coating a substrate with the solution of dispersed nanomaterials to form a first substrate layer, wherein the substrate has a functionalized surface and the reactive polymeric dispersing agent covalently bonds with the functionalized surface of the substrate; and
(c) applying a first layer of matrix material to the first substrate layer, wherein the matrix material comprises a polymeric material, and wherein the polymeric material covalently bonds with the reactive polymeric dispersing agent and the functionalized surface of the substrate.

2. The process of claim 1 wherein the matrix material further comprises nanomaterials and a reactive polymer for non-wrapping non-covalent functionalization of the nanomaterials.

3. The process of claim 1 further comprising applying a second substrate layer to the first layer of matrix material, wherein the first layer of matrix material is sandwiched between the first and second substrate layers.

4. The process of claim 3 further comprising applying additional matrix material layers to the first and second substrate layers and applying additional substrate layers to the additional matrix material layers, wherein a matrix material layer is sandwiched between each substrate layer.

5. The process of claim 2 further comprising applying a second substrate layer to the first layer of matrix material, wherein the first layer of matrix material is sandwiched between the first and second substrate layers.

6. The process of claim 5 further comprising applying additional matrix material layers to the first and second substrate layers and applying additional substrate layers to the additional matrix material layers, wherein a matrix material layer is sandwiched between each substrate layer.

7. The process of claim 1 wherein the nanomaterials are selected from the group consisting of multi-wall carbon nanotubes, multi-wall boron nitride nanotubes, single-wall carbon nanotubes, single-wall boron nitride nanotubes, carbon nanoparticles, boron nitride nanoparticles, carbon nanofibers, boron nitride nanofibers, carbon nanoropes, boron nitride nanoropes, carbon nanoribbons, boron nitride nanoribbons, carbon nanofibrils, boron nitride nanofibrils, carbon nanoneedles, boron nitride nanoneedles, carbon nanosheets, boron nitride nanosheets, carbon nanorods, boron nitride nanorods, carbon nanohoms, boron nitride nanohoms, carbon nanocones, boron nitride nanocones, carbon nanoscrolls, boron nitride nanoscrolls, graphite nanoplatelets, nanodots, fullerene materials and combinations thereof.

8. The process of claim 1, wherein the reactive polymeric dispersing agent comprises a poly(phenyleneethynylene)polymer having the following repeat structure:

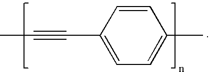

9. The process of claim 1, wherein the nanomaterials are dispersed in the reactive polymeric dispersing agent by at least one of sonication, high shear mixing, three roll mill calendaring, high pressure capillary tube processing, and vibration.

10. The process of claim 1, wherein the substrate comprises a material selected from the group consisting of polymeric material, cotton, fiberglass, metal, and ceramic material.

11. The process of claim 10, wherein the substrate comprises a polymeric material in a form selected from the group consisting of a woven fabric, a non-woven fabric and a film.

12. The process of claim 11, wherein the polymeric material comprises a polymer selected from the group consisting of thermoset polymers, thermoplastic polymers, conducting thermoplastic polymers, elastomers and inorganic polymers.

13. The process of claim 11, wherein the substrate comprises a fabric material comprising fibers selected from the group consisting of carbon fibers, carbon nanotube fibers, carbon nanotube nanocomposite fibers, polyaramid fibers, poly(ρ-phenylene benzobisoxazole) fibers, ultrahigh molecular weight polyethylene fibers, high density polyethylene fibers, low density polyethylene fibers, linear low density polyethylene fibers, polypropylene fibers, nylon fibers, cellulose fibers, natural fibers, biodegradable fibers and combinations thereof.

14. The process of claim 1, wherein the substrate is coated with the solution of dispersed nanomaterials by a technique selected from the group consisting of spraying, vacuum deposition, dip coating, extrusion, calendaring, powder coating, transfer coating, air knife coating, roller coating and brush coating.

15. The process of claim 3 wherein the substrate layers and the matrix material layers are applied to each other by a technique selected from the group consisting of compression molding, resin transfer molding, resin infusion, reaction injection molding, pre-preg, thermoforming, hand lay-up, casting molding, open molding, autoclave molding, filament winding, pultrusion, and combinations thereof.

16. The process of claim 12 wherein the substrate comprises a thermoset polymeric material selected from the group consisting of polyester resin, epoxy resin, polyimides, cyanate esters, bismaleimides, benzoxazines, phthalonitriles, vinylesters, phenolics, poly(ρ-phenylene benzobisoxazole), allyl resin, melamine resin, urea-formaldehyde, melamine formaldehyde, phenol-formaldehyde, polydicyclopentadiene, furfuraldehyde and combinations thereof.

17. The process of claim 12 wherein the substrate comprises a thermoplastic polymer or prepolymer selected from the group consisting of polyethylene, polyphenylenes, poly(phenylene oxide), polyketone, cellulose, polyimide, poly(methyl methacrylate), poly(vinylidene chloride), poly(vinylidene fluoride), polycarbonate, polypropylene, poly(vinyl chloride), poly(ether sulfone), poly(vinyl acetate), polystyrene, polyester, polyvinylpyrrolidone, polycyanoacrylate, polyacrylonitrile, acrylonitrile butadiene styrene, polyamides, poly(aryleneethynylene), poly(phenyleneethynylene), polyester resin, ethylene vinyl alcohol, polytetrafluoroethylene, fluoroethylene propylene, perfluoroalkoxyalkane, chlorotrifluoroethylene, ethylene chlorotrifluoroethylene, ethylene tetrafluoroethylene, polyacrylates, polybutylene, polyethylenechlorinates, polymethylpentene, polyamide-imide, polyaryletherketone, polyetheretherketone, polyetherimide, polyphthalamide, polysulfone and combinations thereof.

18. The process of claim 12 wherein the substrate comprises a conducting thermoplastic polymer selected from the group consisting of poly(acetylene)s, poly(pyrrole)s, poly(thiophene)s, poly(aniline)s, poly(fluorene)s, polynaphthalenes, poly(ρ-phenylene sulfide), poly(ρ-phenylene vinylene)s, ionomers and combinations thereof.

19. The process of claim 12 wherein the substrate comprises an elastomer selected from the group consisting of polyisoprene, polybutadiene, polyisobutylene, polychloroprene, silicone, polyurethane, styrene butadiene rubber, hydrogenated nitrile butadiene rubber and combinations thereof.

20. The process of claim 12 wherein the substrate comprises an inorganic polymer selected from the group consisting of polysiloxane, polysilane, polycarbosilane, polygermane, polystannane, polyphosphazene and combinations thereof.

21. The process of claim 8, wherein the reactive polymeric dispersing agent comprises a poly(phenyleneethynylene) polymer that comprises a structure selected from the group consisting of Pₐ, P_{b} and P_{c}: 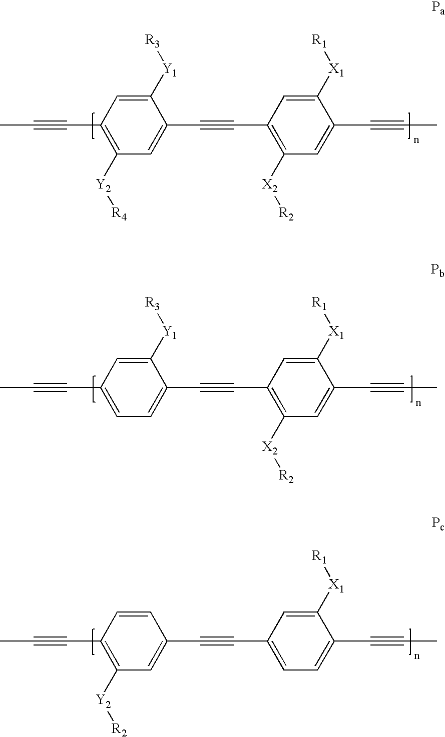
wherein n is from about 20 to about 190;
wherein X₁, X₂, Y₁, and Y₂ are independently selected from the group consisting of CO, COO, CONH, CONHCO, COOCO, CONHCNH, CON, COS, CS, CN, CNN, SO, SO₂, NO, PO; C₁ to C₅₀ alkyl, aryl, allyl, N, S, O, or P;
and wherein R₁, R₂, R₃ and R₄ are independently selected from the group consisting of an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, alkyl, allyl, antibiotic, aryl, azide, aziridine, azo compounds, benzyl, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, epoxide, ester, ether, ethylene glycol, fullerene, glyoxal, halide, hydrogen, hydroxy, imide, imine, imidoester, isothiocyanate, isocyanate, isonitrile, ketone, lactone, ligand for metal complexation, ligand for biomolecule complexation, lipid, maleimide, melamine, metallocene, NHS ester, nitrile, nitroalkane, nitro compounds, nucleotide, olefin, oligosaccharide, peptide, phenyl, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane, pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, urethane and combinations thereof.

22. The process of claim 8, wherein the reactive polymeric dispersing agent comprises a poly(phenyleneethynylene) that comprises structure P_{d}: 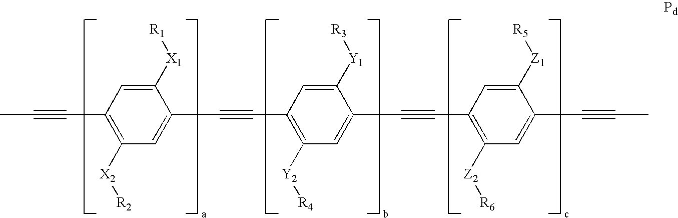
wherein X₁, X₂, Y₁, Y₂, Z₁ and Z₂ are independently selected from the group consisting of CO, COO, CONH, CONHCO, COOCO, CONHCNH, CON, COS, CS, CN, CNN, SO, SO₂, NO, PO; C₁ to C₅₀ alkyl, aryl, allyl, N, S, O, or P;
wherein a+c=b and b is greater than 10 and less than 96; and
wherein R₁, R₂, R₃, R₄, R₅ and R₆ are independently selected from the group consisting of an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, alkyl, allyl, antibiotic, aryl, azide, aziridine, azo compounds, benzyl, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, epoxide, ester, ether, ethylene glycol, fullerene, glyoxal, halide, hydrogen, hydroxy, imide, imine, imidoester, isothiocyanate, isocyanate, isonitrile, ketone, lactone, ligand for metal complexation, ligand for biomolecule complexation, lipid, maleimide, melamine, metallocene, NHS ester, nitrile, nitroalkane, nitro compounds, nucleotide, olefin, oligosaccharide, peptide, phenyl, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, urethane and combinations thereof.

23. The process of claim 1 wherein the solvent is selected from the group consisting of water, acetic acid, acetone, acetonitrile, aniline, benzene, benzonitrile, benzyl alcohol, bromobenzene, bromoform, 1-butanol, 2-butanol, carbon disulfide, carbon tetrachloride, chlorobenzene, chloroform, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, or N-methyl-2-pyrrolidone.

24. The process of claim 1 wherein the solvent is selected from the group consisting of tetra-n-butylphosphonium bromide, tetra-n-butylammonium bromide, 1-ethyl-3-methyl-imidazolium chloride, 1-butyl-3-methyl-imidazolium chloride, 1-hexyl-3-methyl-imidazolium chloride, 1-methyl-3-octyl-imidazolium chloride, 1-butyl-4-methyl-pyridinium chloride, 1-ethyl-3-methyl-imidazolium tetrafluoroborate, 1-butyl-3-methyl-imidazolium tetrafluoroborate, 1-hexyl-3-methyl-imidazolium tetrafluoroborate, 3-methyl-1-octyl-imidazolium tetrafluoroborate, 1-butyl-4-methyl-pyridinium tetrafluoroborate, 1-ethyl-3-methyl-imidazolium hexafluorophosphate, 1-butyl-3-methyl-imidazolium hexafluorophosphate, 1-hexyl-3-methyl-imidazolium hexafluorophosphate, 1-butyl-4-methyl-pyridinium hexafluorophosphate, 1,3-dimethylimidazolium methylsulfate, 1-butyl-3-methyl-imidazolium methylsulfate, dimethylimidazolium triflate, 1-ethyl-3-methylimidazolium triflate, 1-butyl-3-methylimidazolium triflate, 1-butyl-3-ethylimidazolium triflate, supercritical carbon dioxide, supercritical water, supercritical ammonia, supercritical ethylene and combinations thereof.

25. The process of claim 1 wherein the solution of dispersed carbon nanotubes further comprises low molecular weight reactive polymers wherein the low molecular weight reactive polymers covalently bond with the reactive polymeric dispersing agent and the functionalized surface of the substrate.

26. A nanomaterial-containing composite, comprising:
(a) a first substrate layer comprising a substrate having a functionalized surface and a coating disposed on the substrate, the coating comprising nanomaterials and a reactive polymeric dispersing agent, wherein the reactive polymeric dispersing agent covalently bonds with the functionalized surface of the substrate; and
(b) a first matrix layer applied to the first substrate layer, the first matrix layer comprising polymeric material, wherein the polymeric material covalently bonds with the functionalized surface of the substrate and with the reactive polymeric dispersing agent.

27. The nanocomposite of claim 26 wherein the first matrix layer further comprises nanomaterials and a reactive polymeric dispersing agent.

28. The nanocomposite of claim 26 further comprising a second substrate layer applied to the first matrix layer, wherein the first matrix layer is sandwiched between the first and second substrate layers.

29. The nanocomposite of claim 28 further comprising additional substrate layers and additional matrix layers, wherein a matrix layer is sandwiched between each substrate layer.

30. The nanocomposite of claim 27 further comprising a second substrate layer applied to the first matrix layer, wherein the first matrix layer is sandwiched between the first and second substrate layers.

31. The nanocomposite of claim 30 further comprising additional substrate layers and additional matrix layers, wherein a matrix layer is sandwiched between each substrate layer.

32. The nanocomposite of claim 26 wherein the nanomaterials are selected from the group consisting of multi-wall carbon nanotubes, multi-wall boron nitride nanotubes, single-wall carbon nanotubes, single-wall boron nitride nanotubes, carbon nanoparticles, boron nitride nanoparticles, carbon nanofibers, boron nitride nanofibers, carbon nanoropes, boron nitride nanoropes, carbon nanoribbons, boron nitride nanoribbons, carbon nanofibrils, boron nitride nanofibrils, carbon nanoneedles, boron nitride nanoneedles, carbon nanosheets, boron nitride nanosheets, carbon nanorods, boron nitride nanorods, carbon nanohoms, boron nitride nanohoms, carbon nanocones, boron nitride nanocones, carbon nanoscrolls, boron nitride nanoscrolls, graphite nanoplatelets, nanodots, fullerene materials and combinations thereof.

33. The nanocomposite of claim 26, wherein the reactive polymeric dispersing agent comprises a poly(phenyleneethynylene) polymer having the following repeat structure:

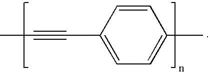

34. The nanocomposite of claim 26, wherein the substrate comprises a material selected from the group consisting of polymeric material, cotton, fiberglass, metal, and ceramic material.

35. The nanocomposite of claim 34, wherein the substrate comprises a polymeric material in a form selected from the group consisting of a woven fabric, a non-woven fabric and a film.

36. The nanocomposite of claim 35, wherein the polymeric material comprises a polymer selected from the group consisting of thermoset polymers, thermoplastic polymers, conducting thermoplastic polymers, elastomers and inorganic polymers.

37. The nanocomposite of claim 35, wherein the substrate comprises a fabric material comprising fibers selected from the group consisting of carbon fibers, carbon nanotube fibers, carbon nanotube nanocomposite fibers, polyaramid fibers, poly(ρ-phenylene benzobisoxazole) fibers, ultrahigh molecular weight polyethylene fibers, high density polyethylene fibers, low density polyethylene fibers, linear low density polyethylene fibers, polypropylene fibers, nylon fibers, cellulose fibers, natural fibers, biodegradable fibers and combinations thereof.

38. The nanocomposite of claim 36 wherein the substrate comprises a thermoset polymeric material selected from the group consisting of polyester resin, epoxy resin, polyimides, cyanate esters, bismaleimides, benzoxazines, phthalonitriles, vinylesters, phenolics, poly(ρ-phenylene benzobisoxazole), allyl resin, melamine resin, urea-formaldehyde, melamine formaldehyde, phenol-formaldehyde, polydicyclopentadiene, furfuraldehyde and combinations thereof.

39. The nanocomposite of claim 36 wherein the substrate comprises a thermoplastic polymer or prepolymer selected from the group consisting of polyethylene, polyphenylenes, poly(phenylene oxide), polyketone, cellulose, polyimide, poly(methyl methacrylate), poly(vinylidene chloride), poly(vinylidene fluoride), polycarbonate, polypropylene, poly(vinyl chloride), poly(ether sulfone), poly(vinyl acetate), polystyrene, polyester, polyvinylpyrrolidone, polycyanoacrylate, polyacrylonitrile, acrylonitrile butadiene styrene, polyamides, poly(aryleneethynylene), poly(phenyleneethynylene), polyester resin, ethylene vinyl alcohol, polytetrafluoroethylene, fluoroethylene propylene, perfluoroalkoxyalkane, chlorotrifluoroethylene, ethylene chlorotrifluoroethylene, ethylene tetrafluoroethylene, polyacrylates, polybutylene, polyethylenechlorinates, polymethylpentene, polyamide-imide, polyaryletherketone, polyetheretherketone, polyetherimide, polyphthalamide, polysulfone and combinations thereof.

40. The nanocomposite of claim 36 wherein the substrate comprises a conducting thermoplastic polymer selected from the group consisting of poly(acetylene)s, poly(pyrrole)s, poly(thiophene)s, poly(aniline)s, poly(fluorene)s, polynaphthalenes, poly(ρ-phenylene sulfide), poly(ρ-phenylene vinylene)s, ionomers and combinations thereof.

41. The nanocomposite of claim 36 wherein the substrate comprises an elastomer selected from the group consisting of polyisoprene, polybutadiene, polyisobutylene, polychloroprene, silicone, polyurethane, styrene butadiene rubber, hydrogenated nitrile butadiene rubber and combinations thereof.

42. The nanocomposite of claim 36 wherein the substrate comprises an inorganic polymer selected from the group consisting of polysiloxane, polysilane, polycarbosilane, polygermane, polystannane, polyphosphazene and combinations thereof.

43. The nanocomposite of claim 33, wherein the reactive polymeric dispersing agent comprises a poly(phenyleneethynylene) polymer that comprises a structure selected from the group consisting of Pₐ, P_{b} and P_{c}: 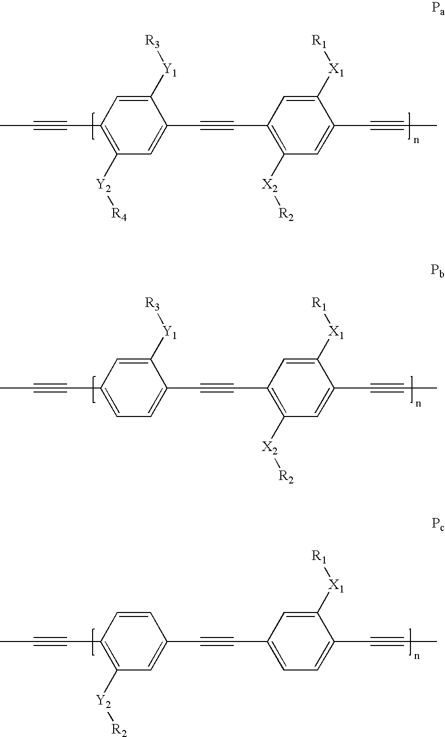
wherein n is from about 20 to about 190;
wherein X₁, X₂, Y₁, and Y₂ are independently selected from the group consisting of CO, COO, CONH, CONHCO, COOCO, CONHCNH, CON, COS, CS, CN, CNN, SO, SO₂, NO, PO; C₁ to C₅₀ alkyl, aryl, allyl, N, S, O, or P; and
wherein R₁, R₂, R₃ and R₄ are independently selected from the group consisting of an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, alkyl, allyl, antibiotic, aryl, azide, aziridine, azo compounds, benzyl, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, epoxide, ester, ether, ethylene glycol, fullerene, glyoxal, halide, hydrogen, hydroxy, imide, imine, imidoester, isothiocyanate, isocyanate, isonitrile, ketone, lactone, ligand for metal complexation, ligand for biomolecule complexation, lipid, maleimide, melamine, metallocene, NHS ester, nitrile, nitroalkane, nitro compounds, nucleotide, olefin, oligosaccharide, peptide, phenyl, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane, pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, urethane and combinations thereof.

44. The nanocomposite of claim 33, wherein the reactive polymeric dispersing agent comprises a poly(phenyleneethynylene) that comprises structure P_{d}: 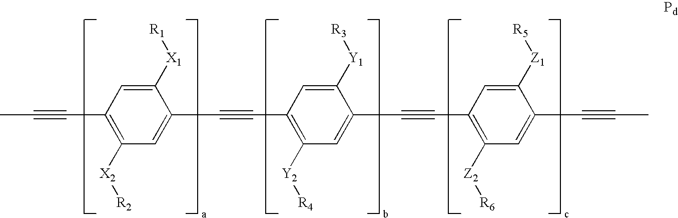
wherein X₁, X₂, Y₁, Y₂, Z₁ and Z₂ are independently selected from the group consisting of CO, COO, CONH, CONHCO, COOCO, CONHCNH, CON, COS, CS, CN, CNN, SO, SO₂, NO, PO; C₁ to C₅₀ alkyl, aryl, allyl, N, S, O, or P;
wherein a+c=b and b is greater than 10 and less than 96; and
wherein R₁, R₂, R₃, R₄, R₅ and R₆ are independently selected from the group consisting of an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, alkyl, allyl, antibiotic, aryl, azide, aziridine, azo compounds, benzyl, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, epoxide, ester, ether, ethylene glycol, fullerene, glyoxal, halide, hydrogen, hydroxy, imide, imine, imidoester, isothiocyanate, isocyanate, isonitrile, ketone, lactone, ligand for metal complexation, ligand for biomolecule complexation, lipid, maleimide, melamine, metallocene, NHS ester, nitrile, nitroalkane, nitro compounds, nucleotide, olefin, oligosaccharide, peptide, phenyl, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, urethane and combinations thereof.

45. The nanocomposite of claim 44,
wherein X₁R₁═X₂R₂, Y₁R₃═Y₂R₄, and Z₁R₅=Z₂R₆;
wherein X₁═X₂═COO, Y₁═Y₂═O and Z₁=Z₂=COO; and
wherein R₁═R₂═(CH₂)₈((CH₂)₂O), R₃═R₄═C₁₀H₂₁, and R₅═R₆═(C₂H₄O)₃CH₃.

46. The nanocomposite of claim 26, wherein the nanocomposite comprises from 0.25 to 10 percent by weight of the nanomaterials.

47. The nanocomposite of claim 27, wherein the nanocomposite comprises from 0.1 to 20 percent by weight of the nanomaterials.

48. The nanocomposite of claim 26, wherein the nanocomposite comprises from 0.1 to 40 percent by weight of the reactive polymeric dispersing agent.

49. The nanocomposite of claim 26, wherein the nanocomposite has an in-plane electrical resistivity of about 30-60 Ω-cm.

50. A nanocomposite, comprising:
(a) a first substrate layer comprising a polyethylene fabric substrate having a functionalized surface and a coating disposed on the substrate, the coating comprising multi-wall carbon nanotubes and a reactive polymeric dispersing agent, wherein the reactive polymeric dispersing agent covalently bonds with the functionalized surface of the substrate, and wherein the reactive polymeric dispersing agent comprises a poly(phenyleneethynylene)polymer that comprises structure P_{d}: 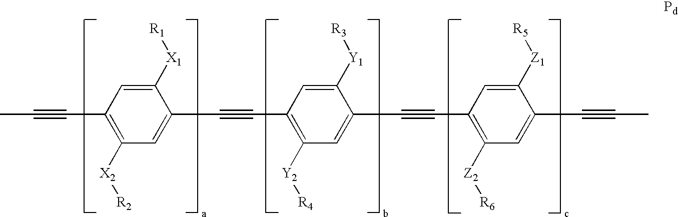
wherein X₁R₁═X₂R₂, Y₁R₃═Y₂R₄, and Z₁R₅=Z₂R₆;
wherein X₁═X₂═COO, Y₁═Y₂═O and Z₁=Z₂=COO;
wherein R₁═R₂═(CH₂)₈((CH₂)₂O), R₃═R₄═C₁₀H₂₁, and R₅═R₆═(C₂H₄O)₃; and
wherein a+c=b and b is greater than 10 and less than 96; and
(b) a first matrix layer applied to the first substrate layer, the first matrix layer comprising epoxy resin, carbon nanotubes and the reactive polymeric dispersing agent, wherein the epoxy resin covalently bonds with the functionalized surface of the substrate and with the reactive polymeric dispersing agent;
wherein the nanocomposite comprises 8.0 percent by weight of the multi-wall carbon nanotubes; and
wherein the nanocomposite has an electrical resistivity of from 52 to 57 Ω-cm.
